(19) United States
(12) Patent Application Publication
(10) Pub. No.: US 2024/0353178 A1
(43) Pub. Date: Oct. 24, 2024

(54) SYSTEMS AND METHODS RELATED TO HEATING AND/OR QUENCHING LITHIUM-CONTAINING METAL OXIDES

(71) Applicant: Stratus Materials Inc., Pittsburgh, PA (US)

(72) Inventors: Jay F. Whitacre, Pittsburgh, PA (US); Jared Mitchell, Pittsburgh, PA (US); Eric Weber, Pittsburgh, PA (US)

(73) Assignee: Stratus Materials Inc., Pittsburgh, PA (US)

(21) Appl. No.: 18/639,725

(22) Filed: Apr. 18, 2024

Related U.S. Application Data
(60) Provisional application No. 63/596,147, filed on Nov. 3, 2023.
(60) Provisional application No. 63/460,441, filed on Apr. 19, 2023.

(51) Int. Cl. F27B 7/33; C01G 53/00; F27B 7/38; H01M 4/505

(52) U.S. Cl. CPC F27B 7/33; C01G 53/50; F27B 7/383; H01M 4/505; C01P 2002/50; C01P 2002/72; C01P 2004/04; C01P 2006/40

(57) ABSTRACT

A thermal processing system includes a tilted rotary furnace configured to sinter a powder at a sintering temperature, a quenching apparatus configured to quench the sintered powder in a quench fluid, and a transfer conduit configured to provide the sintered powder having the sintering temperature from the tilted rotary furnace to the quenching apparatus in 500 ms or less.

### TECHNICAL FIELD

Aspects of the present invention relate to furnaces for ceramic powder processing and to methods of using thereof to form lithium-rich lithium nickel manganese oxide cathode active materials.

### BACKGROUND

Cobalt containing cathode material in lithium-ion batteries accounts for substantial fraction of the cost of a contemporary battery cell, and the cobalt is a key contributor to the cost. Cobalt has supply chain complexities that make it a volatile commodity. As such, there is a need for reliable cobalt-free lithium-ion battery cathode materials.

### SUMMARY

Aspects of the present invention relate to furnaces for ceramic powder processing and to methods of using thereof to form lithium-rich lithium nickel manganese oxide cathode active materials. The subject matter of the present invention involves, in some cases, interrelated products, alternative solutions to a particular problem, and/or a plurality of different uses of one or more systems and/or articles.

According to various embodiments, a thermal processing system includes a tilted rotary furnace configured to sinter a powder at a sintering temperature, a quenching apparatus configured to quench at least a portion of the sintered powder in a quench fluid, and a transfer conduit configured to provide at least a portion of the sintered powder having the sintering temperature from the tilted rotary furnace to the quenching apparatus in 500 ms or less.

According to various embodiments, a method includes sintering a powder at a sintering temperature in a tilted rotary furnace and providing at least a portion of the sintered powder having the sintering temperature from the tilted rotary furnace at least in part by a force of gravity through a transfer conduit into a quench fluid in a quenching apparatus in 500 ms or less.

Other advantages and novel features of the present invention will become apparent from the following detailed description of various non-limiting embodiments of the invention when considered in conjunction with the accompanying figures. In cases where the present specification and a document incorporated by reference include conflicting and/or inconsistent disclosure, the present specification shall control.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention. In the figures:

FIG. 1A is a schematic cross-sectional diagram of an example of a thermal processing system, according to one set of embodiments;

FIG. 1B is a perspective view of an example of a thermal processing system, according to one set of embodiments;

FIG. 1C is a schematic view of an example of a circulated quenching apparatus, according to one set of embodiments;

FIG. 1D is a schematic view of an example of a circulated quenching apparatus, according to one set of embodiments;

FIG. 1E is a schematic view of an example of a circulated quenching apparatus, according to one set of embodiments;

FIG. 2A is a photograph of a rapid quenching system, according to one set of embodiments;

FIG. 2B includes 4 sequential video capture time-laps images filmed at 30 frames per second, showing a rapid quenching process, according to one set of embodiments;

FIGS. 3 and 4 are graphs showing X-ray diffraction (XRD) patterns for Liₓ(Mn_{y}Ni_{1-y})₂₋ₓO₂ materials, where x=1.2, and y=0.75 before and after rapid quenching respectively, according to one set of embodiments;

FIG. 5 is a graph showing X-ray diffraction pattern for a Liₓ(Mn_{y}Ni_{1-y})₂₋ₓO₂ material, where x=1.16, and y=0.7, according to one set of embodiments;

FIG. 6 is a graph illustrating X-ray diffraction pattern for a Liₓ(Mn_{y}Ni_{1-y})₂₋ₓO₂ material, where x=0.116, and y=0.7, that was processed using microwave heating and ultra-rapid quenching, according to one set of embodiments;

FIG. 7A is a transmission electron microscopy (TEM) atomic map micrograph of an LRMO material that was not subjected to rapid quenching prior to electrochemically cycling the material, according to one set of embodiments;

FIG. 7B is a TEM HAADF atomic map micrograph of a LRMO material that was subjected to rapid quenching prior to electrochemically cycling the material, according to one set of embodiments;

FIG. 8A is a graph showing cell potential vs. specific capacity, according to one set of embodiments;

FIG. 8B is a graph of the specific capacity vs cycle for a comparative example of a Liₓ(Mn_{y}Ni_{1-y})₂₋ₓO₂ material, where x=1.16, and y=0.7, that was neither microwave processed nor rapid quenched (in this case cooled relatively slowly on a metal plate);

FIG. 9A is a graph showing cell potential vs. specific capacity during break-in cycles, according to one set of embodiments;

FIG. 9B is a graph showing cell potential vs specific capacity over time, and FIG. 9C is a graph showing specific capacity vs cycle at C/20 rate for exemplary cells including LRMO active materials according to one set of embodiments;

FIG. 10A is a graph showing cell potential vs specific capacity for two comparative cells including a Liₓ(Mn_{y}Ni_{1-y})₂₋ₓO₂ active material, where x=01.2, and y=0.75, that was not rapid quenched, according to one set of embodiments; and

FIG. 10B is a graph showing a specific capacity vs cycle for the quenched material of FIG. 10A.

FIG. 11 is a chart showing X-ray diffraction pattern results for an S-LRMO active material having the formula: Li[Li_{0.14}Na_{0.06}Mn_{0.6}Ni_{0.2}]O₂, according to one set of embodiments;

FIG. 12 is a chart showing X-ray diffraction pattern results for an S-LRMO active material having the formula: Li[Li_{0.06}Na_{0.14}Mn_{0.6}Ni_{0.2}]O₂, according to one set of embodiments;

FIG. 13 is a chart showing X-ray diffraction pattern results for an S-LRMO active material having the formula: Li[Li_{0.06}K_{0.14}Mn_{0.6}Ni_{0.2}]O₂, according to one set of embodiments;

FIG. 14 is a chart showing X-ray diffraction pattern results for an S-LRMO active material having the formula: Li[Li_{0.06} Na_{0.07}K_{0.07}Mn_{0.6}Ni_{0.2}]O₂, according to one set of embodiments;

FIG. 15 is a chart showing electrochemical data including charge/discharge performance for an S-LRMO material, according to one set of embodiments;

FIG. 16 is a chart showing electrochemical data including charge/discharge performance for an S-LRMO material, according to one set of embodiments;

FIG. 17 is a chart showing electrochemical data including cycle life for an S-LRMO material, according to one set of embodiments;

FIG. 18 is a chart showing electrochemical data including charge/discharge performance for an S-LRMO material, according to one set of embodiments;

FIG. 19 is a chart showing electrochemical data including efficiency as a function of cycle number for an S-LRMO material, according to one set of embodiments;

FIG. 20 is a chart showing electrochemical data including cycle life for an S-LRMO material, according to one set of embodiments;

FIG. 21 is a chart showing electrochemical data including charge/discharge performance for an S-LRMO material, according to one set of embodiments;

FIG. 21 is a chart showing electrochemical data including charge/discharge performance for an S-LRMO material, according to one set of embodiments;

FIG. 23 is a chart including rate capability data of a potassium substituted LRMO material, according to one set of embodiments;

FIG. 24 is a chart showing data for the first two charge/discharge cycles for a lithium metal half-cell made using the material: Li[Li_{0.015}Na_{0.155}Mn_{0.58}Ni_{0.25}]O₂, which shows specific capacity of over 250 mAh/g at C/20 rate, according to one set of embodiments; and

FIG. 25 is a chart showing cycle life data from a lithium metal anode half-cell made of the material: Li[Li_{0.015}Na_{0.155}Mn_{0.58}Ni_{0.25}]O₂, which shows stable capacity retention and repeated reference cycles well over 200 mAh/g, according to one set of embodiments. The median discharge voltage is also nominal stable, which is not typical for lithium rich cathode materials.

### DETAILED DESCRIPTION

Aspects of this disclosure relate to thermal processing systems configured to heat and quench powder (e.g., powder of cathode active materials). It has been realized in the context of this disclosure that certain configurations of thermal processing systems, such as those with a furnace configured to sinter the powder while also agitating the powder, can provide for advantageous thermal profiles for each particulate of the powder and then rapidly quench the powder. The thermal processing system may be configured to provide sintered powder from the furnace to a quench apparatus while the powder still has a relatively high temperature (e.g., within 200 degrees Celsius) of the sintering powder, which may provide advantageous quenching compared to certain existing systems (e.g., those in which significant cooling of the powder is performed prior to exiting the furnace).

In some, but not necessarily all embodiments, the powder input into the thermal processing system comprises a lithium-rich metal oxide (LRMO). According to various embodiments, a method of quickly and inexpensively forming a crystallographically-stable, highly durable, cobalt-free, lithium-rich metal oxide (LRMO) material is provided. In some embodiments, the LRMO material is a lithium-rich, lithium manganese nickel oxide material represented by the following general Formula 1:

Liₓ(Mn_{y}Ni_{1-y})₂₋ₓO₂, (1)

wherein x is greater than 1.0 and less than 1.25, and y is less than or equal to 0.95 and greater than or equal to 0.1, for example y may be greater than or equal to 0.5 and less than or equal to 0.8.

In some embodiments, the LRMO material may be a lithium-rich, lithium manganese nickel oxide material represented by the following Formula 2:

Li[Li_{(1/3-2x/3)}Mn_{(2/3-x/3)}Niₓ]O₂, (2)

wherein x is greater than or equal to 0.1 and less than or equal to 0.4.

The LRMO material in its pristine state (e.g., before it is charged for the first time), may have, in some embodiments, distinct hexagonal (e.g., rhombohedral) and monoclinic phases. Thus, in some embodiments, the LRMO material may also be represented by the expression: (1-x)[Li₂MnO₃]*x[LiMnₐNi₍₁₋ₐ₎O₂] instead, wherein the first part of this expression denotes the relative molar amount of the monoclinic phase (1-x), while the second part of this expression denotes the relative molar amount of the rhombohedral phase (x). In some embodiments, the molar fraction of the rhombohedral phase, “x”, is commonly in the range of greater than or equal to 0.8 and less than or equal to 0.95, while “a” is greater than or equal to 0.6 and less than or equal to 0.9. In some embodiments, the two phases may be disposed in a layered structure.

Various embodiments may provide LRMO materials that exhibit high (e.g., >240 mAh/g) specific capacities and high functional voltage windows (e.g., greater than or equal to 2.0 and less than or equal to 4.8 V), when used as an active material of a cobalt-free cathode.

According to various embodiments, methods of forming LRMO materials include rapid thermal processing and rapid (e.g., less than 10 seconds) or ultra-rapid (e.g., less than 500 milliseconds) quenching that result in a LRMO material having a superior crystal structure with a desired atomic order/disorder. These features may provide unexpectedly robust long-term stability and performance when used as a cathode active material.

Certain LRMO materials (e.g., synthesized without rapid quenching and/or quenching in water) may be unsuitable for use as a cathode active material due to having a low rate capability and/or poor capacity retention, which are believed to result from, for example, structural instability due to oxygen losses, transition metal ion migration during use, and/or possible manganese dissolution. Without wishing to be bound by any particular theory, the two most common aging mechanisms manifest as a fade in the average discharge voltage as the material slowly re-organizes into a predominant spinel structure, and loss in capacity over cycling due mechanical and/or chemical degradation of the material.

### Thermal Decomposition and Processing

LRMO materials may be synthesized from precursor materials by a variety of methods. The following Table 1 includes particular methods that may be used to synthesize LRMO materials, including precursor synthesis, precursor materials, quenching methods, performance metrics, and discharge capacity (DC) of LRMO material cathodes.

TABLE 1

| Source # | Route | Precursors | Quench | x= | 3rd DC (mAh/g) |
|---|---|---|---|---|---|
| 4 | Sol-gel then | Acetates and | Metallic | 0.50 | 170 |
| | combustion | Nitrates | | 0.33 | 225 |
| | | | | 0.25 | 230 |
| | | | | 0.17 | 235 |
| | | | Slow Cooling | 0.33 | 128 |
| | | | | 0.42 | 138 |
| | | | | 0.50 | 155 |
| | | | | 0.33 | 135 |
| | | | | 0.42 | 150 |
| | | | | 0.50 | 145 |
| | | | | 0.17 | 225 |
| | | | | 0.25 | 255 |
| | | | | 0.33 | 250 |
| | Precipitation | Nitrates and | | 0.42 | 235 |
| 5 | then combustion | Hydroxides | Metallic | 0.50 | 200 |
| 7 | Hydrothermal | Acetates, Nitrates, | none | 0.10 | 200 |
| | | and Hydroxides | | | |
| | Precipitation | Nitrates and | | 0.33 | 190 |
| 9 | then combustion | Hydroxides | LN2 | 0.33 | 110 |
| 10 | Precipitation | Nitrates and | LN2 | 0.50 | |
| | then combustion | Hydroxides | | | |
| 11 | Precipitation | Nitrates and | Slow Cooling | 0.20 | |
| | then combustion | Hydroxides | | | |
| | Sol-gel then | Nitrates and Glycine | | 0.50 | |
| 12 | combustion | | LN2 | 0.40 | |
| 13 | Sol-gel then | Acetates and misc | No mention | 0.20 | |
| | combustion | | | | |
| | | | | 0.25 | 220 |
| | | | | 0.25 | 260 |
| | Precipitation | Chlorides and | | 0.25 | 215 |
| 21 | then combustion | Hydroxides | LN2 | 0.25 | 260 |
| | Sol-gel then | Acetates and Misc | | 0.2 | 210 |
| 22 | combustion | | no mention | 0.2 | 215 |
| 26 | Precipitation | Hydroxides | LN2 | 0.33 | |
| | then combustion | | | | |
| 28 | Precipitation | Sulfates and | No mention | 0.20 | |
| | then combustion | Carboantes | | | |
| 29 | Precipitation | Sulfates, | No mention | 0.23 | 180 |
| | then combustion | Carboantes, | | | |
| | | and Misc | | | |
| | Precipitation | Sulfates, and misc | No mention | | 215 |
| | Sol-Gel | Acetates | No mention | | 215 |
| 30 | Hydrothermal | Acetates and PVP | Na | 0.2 | 225 |

As shown in Table 1, the three main synthetic routes for LRMO materials include precipitation followed by combustion, hydrothermal synthesis, and sol-gel solution production followed by intermediate temperature decomposition and high temperature thermal processing (e.g., calcination, annealing, sintering).

As shown in Table 1, the number of investigations exploring the effects of nickel composition on the performance LRMO cathodes has decreased over time; with few studies exploring multiple nickel compositions or nickel compositions below x=0.2 in cathodes having the formula Li[NiₓLi_{(1/3-2x/3)}Mn_{(2/3-x/3)}]O₂. Table 1 also shows that there are significant inconsistencies in synthetic routes employed across studies. Additionally, there are few studies that perform a detailed comparative assessment relating the effects of synthetic approach to performance of LRMO cathodes. In LRMO materials, the ordering and disordering of transition metals may be important, and both composition and synthetic techniques may provide mechanisms for influencing the degree of structural order and disorder. The electrochemical behaviors these compositional and synthetic changes could impose, such as different defect concentrations for example, may lead to pronounced effects on the properties of LRMO cathodes.

Without wishing to be bound by a particular theory, it is believed that when a sample is quenched in liquid nitrogen the particles are immediately shielded by an insulating envelope of nitrogen gas, similar to the Leidenfrost effect, which significantly reduces heat transfer rate. It is believed that in the preparation of certain traditional cathode materials, lithium containing cathode materials for lithium ion batteries are not brought in contact with moisture because water leaches out lithium from such cathode materials and forms a lithium hydroxide coating on the materials. Furthermore, water is known to cause malfunctions in lithium ion batteries, such as lithium-ion batteries which contain lithium iron phosphate cathode materials.

While not wishing to be bound to a particular theory, the present inventors believe that the relatively slow conventional quenching and cooling process result in agglomeration of metal oxides, thereby forming segregated nickel oxide and lithium manganese oxide phases. In particular, the nickel oxide phase may be concentrated on the surface of LRMO material particles (e.g., crystallites). Without wishing to be bound by any particular theory, this surface nickel oxide agglomeration, and in general nickel and manganese segregation in the crystal structure, may be at least partially responsible for the chemical instability of conventional LRMO active materials.

In contrast, the present inventors have unexpectedly determined that water quenching does not negatively affect the LRMO cathodes and does not cause lithium leaching from such LRMO cathodes. Examples of embodiments in which water quenching is performed with non-substituted LRMOs are described in U.S. Patent Application Publication No. 2023/0015455, published on Jan. 19, 2023, filed as U.S. patent application Ser. No. 17/810,722 on Jul. 5, 2022, and entitled “Lithium-Rich Nickel Manganese Oxide Battery Cathode Materials and Methods,” which is incorporated herein by reference in its entirety for all purposes. It is believed that water quenching results in vaporization in the form of bubble nucleation and dissipation, which actually increases the rate of heat transfer. As such, without wishing to be bound by theory, it is believed that water quenching should generally have a rate of heat transfer that can be approximated as two orders of magnitude greater than liquid nitrogen quenching. Further, in some cases, water and additives solvated into it (i.e., other materials that may be dissolved in the water) may both react with the high temperature LRMO as it quenches to create advantageous surface terminations and/or coatings that enhance electrochemical stability and durability when used in a lithium-ion battery. As described in more detail below, the methods, conditions, parameters, and/or processing steps described above may, in some embodiments, be applied to the substituted LRMO materials described in this disclosure.

Additionally, in many of the quench routes described above in the context of Table 1, the quenching is done on pressed sintered or partially sintered pellets of the material that are intact as larger bodies (e.g., having a width on the order of centimeters). In contrast, in some embodiments of the present disclosure, the quenching is performed on loose and/or milled powder with particles that are in shapes agglomerates that are 20 microns or less in average diameter, such as greater than or equal to 0.1 and less than or equal to 20 microns, for example, greater than or equal to 0.1 and less than or equal to 1 microns or greater than or equal to 1 and less than or equal to 20 microns, in average diameter, such that when the particles contact the quenching liquid (e.g., water) all of the material cools rapidly and at approximately the same rate. Other ranges are also possible. Each agglomerate may be composed of crystallites having an average size of greater than or equal to 25 nm and less than or equal to 500 nm, such as greater than or equal to 50 nm and less than or equal to 200 nm. Other ranges are also possible. Each crystallite may comprise a single crystal of the LRMO material. The crystallites may be partially fused together in the agglomerate or fully fused together in the agglomerate. If the crystallites are fully fused in the agglomerate (i.e., in a powder particle), then each crystallite comprises a single crystal grain of the powder particle which is separated from other single crystal grains in the same powder particle by grain boundaries. The average crystal grain size of the powder particles may be greater than or equal to 25 nm and less than or equal to 500 nm, such as greater than or equal to 50 nm and less than or equal to 200 nm. Other ranges are also possible. The agglomerates may be relatively porous, which allows the water to reach the crystallites inside the agglomerate.

While some of the embodiments described herein generally refer to sintered or partially sintered particles, those of ordinary skill in the art would understand, based upon the teachings of this specification, that the particles are not necessarily fused together (e.g., loose and/or milled particles). In some embodiments, the particles are heated to a temperature (e.g., a sintering temperature as described herein) otherwise suitable for sintering, but which does not necessarily result in fusion between particles. For example, and without wishing to be bound by theory, in some embodiments, the particles are heated to a temperature suitable for encouraging a relatively high degree of atomic disorder in the materials of the particles. In some embodiments, the heating of the particles increases the entropy of the powder material.

In some embodiments, the material subjected to the quenching (e.g., an LRMO or an S-LRMO, described below) comprises a powder comprising particles (e.g., loose particles) having an average largest cross-sectional dimension of less than or equal to 20 microns, less than or equal to 10 microns, less or equal to 5 microns, less than or equal 2 microns, or less. In some embodiments, the material subjected to the quenching (e.g., an LRMO or an S-LRMO, described below) comprises a powder comprising particles (e.g., loose particles) having an average largest cross-sectional dimension greater than or equal to 0.1 microns, greater than or equal to 0.2 microns, greater than or equal to 0.5 microns, greater than or equal to 1 micron, or greater. Combinations of these ranges are possible, as noted above. Other ranges are also possible. In some embodiments, the material subjected to the quenching (e.g., an LRMO or an S-LRMO, described below) comprises a powder comprising particles (e.g., loose particles) comprising agglomerates of crystallites having an average largest cross-sectional dimension of greater than or equal to 25 nm, greater than or equal to 50 nm, greater than or equal to 100 nm or greater. In some embodiments, the material subjected to the quenching (e.g., an LRMO or an S-LRMO, described below) comprises a powder comprising particles (e.g., loose particles) comprising agglomerates of crystallites having an average largest cross-sectional dimension of less than or equal to 500 nm, less than or equal to 300 nm, less than or equal to 200 nm, or less. Combinations of these ranges are possible. Other ranges are also possible. The average largest cross-sectional dimensions of the particles and/or crystals may be determined by, for example transmission electron microscopy.

Advantageously, in some embodiments, at least a portion of the particles (at least 10%, at least 30%, at least 50%, at least 70%, at least 90%, at least 95%, at least 98%, at least 99%) experience a relatively similar change in temperature over time relative to one another. That is to say, in some embodiments, the quenching apparatus and/or systems described herein provide a uniform temperature rate of change to at least a portion of the particles during quenching.

### Rapid and Ultra-Rapid Quenching

According to various embodiments, a LRMO cathode active material may be formed by thermally processing (e.g., sintering, calcining, and/or annealing) and quenching the LRMO material powder. In particular, the thermal processing may include a high-temperature process where the LRMO material may be heated to a sintering temperature of greater than or equal to 800° C. and less than or equal to 1000° C., such as greater than or equal to from 850° C. and less than or equal to 950° C., or 900° C. Other ranges are also possible. The thermal processing may be carried out in any suitable thermal processing apparatus, such as a furnace, for example a tube furnace, muffle box furnace, rotary hearth kiln, belt furnace, etc. As described in more detail below, in some embodiments the furnace is configured to agitate powder (e.g., powder of an LRMO material) during at least a portion of the thermal processing (e.g., during sintering). In some embodiments, the thermal processing may optionally include one or more low-temperature precursor decomposition (e.g., firing) processes where the LRMO material is heated to a temperature above room temperature and below 800° C. For example, the firing may include heating the LRMO material to a temperature of greater than or equal to 450° C. and less than or equal to 550° C., such as 500° C., prior to the high-temperature process. Other ranges are also possible.

According to various embodiments, the quenching process may include transferring the heated LRMO material to a quench bath. The quench bath may be part of a quench fluid in the quenching apparatus described in this disclosure. For example, the LRMO material may be dropped directly into from the thermal processing apparatus into the quench bath. As described in more detail below, the methods, conditions, parameters, and/or processing steps described above may, in some embodiments, be applied to the substituted LRMO materials described in this disclosure.

In some existing methods, the LRMO material may slowly cool during transfer from the furnace. For example, the transfer process may take up to 10 seconds, during which the temperature of the LRMO material may be slowly reduced. The present inventors have determined that slow cooling prior to entering the quench bath may result in undesirable changes to the crystal structure of the sintered LRMO material. In other words, the temperature at which the sintered LRMO material enters the quench bath may be important to providing a desired crystal structure. For example, slow cooling may result in a less desirable crystal structure.

According to various embodiments, the transfer process may be configured such that the sintered LRMO material enters the quench bath after a sintering process at a temperature of at least 800° C., such as a temperature of greater than or equal to 800° C. and less than or equal to 950° C., or greater than or equal to 850° C. and less than or equal to 925° C., or 900° C. For example, the transfer time from the thermal processing apparatus to the quench bath may be limited to 10 seconds or less, such as 1 seconds or less, such as less than 0.5 seconds, or 0.2 seconds or less. Thus, the sintered LRMO material is cooled from the thermal processing temperature (e.g., from the sintering temperature of at least 800° C., such as a temperature of greater than or equal to 800° C. and less than or equal to 950° C., or greater than or equal to 850° C. and less than or equal to 925° C., or 900° C.) in 10 seconds or less, such as less than 0.5 seconds, including 0.2 seconds or less. Other ranges are possible. Herein, an “ultra-rapid quenching process” may have a cooling time of less than 0.5 seconds, such as 0.2 seconds or less, for example greater than or equal to 0.1 and less than or equal to 0.2 seconds, and a “rapid quenching process” may have a cooling time of 10 seconds or less, such as greater than or equal to 0.5 seconds and less than or equal to 10 seconds. Other ranges are also possible.

The sintered LRMO powder particles may be quenched in the quench bath at an average rate of at least 50° C./second, such as at least 50° C./second and less than or equal to 10,000° C./second. For example, the sintered LRMO powder particles may be quenched at a rate of greater than or equal to 87.5° C./second and less than or equal to 8750° C./second, such as greater than or equal 1750° C./second, for example greater than or equal to 1750° C./second and less than or equal to 8750° C./second, including greater than or equal to 4375° C./second and less than or equal to 8750° C./second. Other ranges are also possible. Thus, the sintered LRMO material may be quenched from a temperature between the thermal processing temperature (e.g., sintering temperature) of at least 800° C. to the temperature of the quench bath (e.g., room temperature water bath at 25° C.) in 10 seconds or less, such as in less than 500 milliseconds, including 400 milliseconds or less, 300 milliseconds or less, or 200 milliseconds or less. For example, the quenching may occur in a time period of and less than or equal 100 milliseconds and less than or equal to 400 milliseconds, or greater than or equal to 100 and less than or equal to 200 milliseconds. Other ranges are also possible. As described in more detail below, the methods, conditions, parameters, and/or processing steps described above may, in some embodiments, be applied to the substituted LRMO materials described in this disclosure.

In some embodiments, the LRMO material (or S-LRMO material) is quenched from a sintering temperature (e.g., of at least 800° C., such as a temperature of greater than or equal to 800° C. and less than or equal to 1000° C., or greater than or equal to 850° C. and less than or equal to 950° C.) to a quenching temperature that is in the range of greater than or equal to 10° C., greater than or equal to 15° C., greater than or equal to 20° C. and/or less than or equal to 120° C., less than or equal to 100° C., less than or equal to 80° C., less than or equal to 60° C., less than or equal to 50° C., less than or equal to 45° C., less than or equal to 40° C., less than or equal to 35° C., less than or equal to 30° C., less than or equal to 25° C., or less. In some embodiments, the quenching temperature is room temperature (e.g., 25° C.). The quenching may occur in less than or equal to 500 milliseconds, less than or equal to 400 milliseconds, less than or equal to 300 milliseconds, less than 200 milliseconds, and/or as low as 150 milliseconds, as low as 100 milliseconds, or less. Combinations of these ranges (e.g., quenching occurring in a time period of greater than or equal to 100 milliseconds and less than or equal to 500 milliseconds, or greater than or equal to 100 milliseconds and less than or equal to 200 milliseconds) are possible. Other ranges are also possible.

In some embodiments, the quenching (e.g., within the time periods discussed above) comprises bringing at least 25 wt %, at least 50 wt %, at least 80 wt %, at least 90 wt %, at least 95 wt %, at least 98 wt %, at least 99 wt %, at least 99.9 wt %, or more (e.g., 100 wt %) of the sintered LRMO material (or S-LRMO material) to thermal equilibrium (e.g., with its surrounding medium such as a quench bath) at a temperature that is within the range of greater than or equal to 10° C., greater than or equal to 15° C., greater than or equal to 20° C. and/or less than or equal to 120° C., less than or equal to 100° C., less than or equal to 80° C., less than or equal to 60° C., less than or equal to 50° C., less than or equal to 45° C., less than or equal to 40° C., less than or equal to 35° C., less than or equal to 30° C., less than or equal to 25° C., or less (e.g., room temperature, such as 25° C.). In some embodiments, the quenching comprises bringing at least 25 volume percent (vol %), at least 50 vol %, at least 80 vol %, at least 90 vol %, at least 95 vol %, at least 98 vol %, at least 99 vol %, at least 99.9 vol %, or more (e.g., 100 vol %) of the sintered LRMO material (or S-LRMO material) to thermal equilibrium (e.g., with its surrounding medium such as a quench bath) at a temperature that is within the range of greater than or equal to 10° C., greater than or equal to 15° C., greater than or equal to 20° C. and/or less than or equal to 120° C., less than or equal to 100° C., less than or equal to 80° C., less than or equal to 60° C., less than or equal to 50° C., less than or equal to 45° C., less than or equal to 40° C., less than or equal to 35° C., less than or equal to 30° C., less than or equal to 25° C., or less (e.g., room temperature, such as 25° C.). Other ranges are also possible.

The quench fluid may include oil, alcohol, or water, and may optionally include an additive. For example, the quench fluid may be an oil bath, an alcohol bath, or a water bath. The quench fluid may also be referred to as a quench bath. The quench fluid or bath may comprise water in an amount of greater than or equal to 50 wt %, greater than or equal to 80 wt %, greater than or equal to 90 wt %, greater than or equal to 95 wt %, greater than or equal to 98 wt %, greater than or equal to 99 wt %, or greater (e.g., 100 wt %). Other ranges are also possible. The quench fluid or bath may include one or more additives such as at least one acid or at least one carbohydrate (e.g., urea or sugar), or a combination thereof, as described above. In some embodiments, the quench fluid or bath is basic in pH (e.g., a pH of greater than 7, greater than or equal to 8, greater than or equal to 9, greater than or equal to 10, greater than or equal to 11, greater than or equal to 12, greater than or equal to 14, or greater). In some embodiments, the quench fluid or bath includes a base as an additive, such as LiOH, NaOH, and/or KOH.

The quench bath may comprise a high heat capacity liquid solvent having a vaporization temperature of below 200° C. For example, the quench bath may comprise a solvent, such as water, an oil, and/or an alcohol. In some embodiments, the quench bath may comprise additives configured to modify the surface of the LRMO material during quenching to improve long term chemical stability of the material. The additive may comprise an acid, a base, an alcohol and/or a dissolved carbon species, such as the acid, the alcohol or the carbon species (e.g., urea) dissolved in water.

For example, the quench bath may be an aqueous quenching solution that includes greater than or equal to 0.01 and less than or equal to 1.0 moles per liter, such as greater than or equal to 0.1 and less than or equal to 1.0 moles per liter, or greater than or equal to 0.5 and less than or equal to 1.0 moles per liter, of an acid additive, such as sulfuric acid, hydrochloric acid, nitric acid, oxalic acid, citric acid, acetic acid, phosphoric acid, orthophosphoric acid, lithium hydroxide, sodium hydroxide, potassium hydroxide, combinations thereof, or the like. Other ranges are also possible. The acid may be configured to stabilize the surface of the LRMO particles by reacting with and/or passivating dangling bonds and/or OH terminal groups of the LRMO power particles that are being quenched in the water containing the acid additive.

In some embodiments, the acid quenching may result in the formation of a spinel structure (e.g., surface layer) on the surfaces the quenched LRMO powder particles. The spinel structure may form a framework that stabilizes the particles and provides three-dimensional pathways for lithium diffusion. In particular, it is believed that the acid may result in an exchange of Li ions of the particles with H ions of the acid, and a subsequent structural transformation of the surface of the particles, resulting in the formation of the spinel surface layer.

In another embodiment, the quenching solution may include an alcohol and/or a carbohydrate additive in addition to or in place of the acid additive. For example, the alcohol may include isopropyl alcohol or another alcohol, and the carbohydrate may include urea or a sugar, such as fructose, galactose glucose, lactose, maltose, sucrose, combinations thereof, or the like. In some embodiments, the quenching solution may include greater than or equal to 0.01 and less than or equal to 1.0 moles per liter, such as greater than or equal to 0.1 and less than or equal to 1.0 mole per liter, or greater than or equal to 0.5 and less than or equal to 1.0 mole per liter, of the carbohydrate additive. Other ranges are also possible. In some embodiments, the carbohydrates form an intimate amorphous carbon coating on the surface of the LRMO powder particles during the quenching process in water containing the carbohydrate particle. Without wishing to be bound by any particular theory, carbon coating may advantageously be permeable to Li ions but may be impermeable to an electrolyte of the Li-ion battery. The carbon coating may also permit volumetric changes in the LRMO crystallites to occur during charging and discharging of the battery. As described in more detail below, the methods, conditions, parameters, and/or processing steps described above may, in some embodiments, be applied to the substituted LRMO materials described in this disclosure.

The rapid or ultra-rapid quenching processes may produce a quenched LRMO material having a crystal structure that provides unexpected robustness and electrical characteristics. Specifically, the degree of crystalline order in the quenched LRMO material (e.g., lithium-rich lithium manganese nickel oxide) that is produced by the quenching processes may provide performance characteristics that are suited for use as a cathode active material of a lithium-ion battery that provides energy density and charge storage stability characteristics that are similar to that of cathodes that include cobalt-containing, high nickel-content, active materials.

The quenching processes may produce a quenched LRMO material powder having a desired crystal structure and particle size. For example, the sintered LRMO material being quenched may be a loose powder having an average particle size of 1 μm or less, such as an average particle size ranging of greater than or equal to 0.02 μm and less than or equal to 1 μm, or greater than or equal to 0.05 μm and less than or equal to 0.5 μm. Other ranges are also possible. The quenched LRMO material may include crystal phases and/or crystallites having an average crystal size of greater than or equal to 25 nm and less than or equal to 500 nm, such as greater than or equal to 50 nm and less than or equal to 300 nm, in some embodiments. Each powder particle may comprise one crystallite or more than one crystallite. The loose sintered and quenched powder particles may be incorporated into a binder (e.g., carbon binder) to form a cathode electrode for a Li-ion battery. Other ranges are also possible.

In some embodiments, the sintered and/or quenched LRMO material (or sintered and/or quenched S-LRMO material described below) comprises a loose powder comprising particles having an average largest cross-sectional dimension of less than or equal to 1 micron, less than or equal to 0.5 microns, or less. In some embodiments, the sintered and/or quenched LRMO material (or S-LRMO material described below) is a loose powder comprising particles having an average largest cross-sectional dimension of greater than or equal to 0.02 microns, greater than or equal to 0.05 microns, greater than or equal to 0.1 microns, greater than or equal to 0.2 microns, or greater. Combinations of these ranges (e.g., greater than or equal to 0.02 microns and less than or equal to 1 micron, or greater than or equal to 0.05 micron and less than or equal to 0.5 micron) are possible. Other ranges are also possible.

In some embodiments, the sintered and/or quenched LRMO material (or sintered and/or quenched S-LRMO material described below) comprises a loose powder comprising particles having crystal phase and/or crystallites having an average largest cross-sectional dimension of less than or equal to 500 nm, less than or equal to 300 nm, less than or equal to 200 nm, or less. In some embodiments, the sintered and/or quenched LRMO material (or sintered and/or quenched S-LRMO material described below) comprises a loose powder comprising particles having crystal phase and/or crystallites having an average largest cross-sectional dimension of greater than or equal to 25 nm, greater than or equal to 50 nm, greater than or equal to 100 nm, greater than or equal to 150 nm, or greater. Combinations of these ranges (e.g., greater than or equal to 25 nm and less than or equal to 500 nm, greater than or equal to 50 nm and less than or equal to 300 nm) are possible. Other ranges are also possible.

The quenched LRMO material may be dried to form a LRMO active material (e.g., the thermally processed and quenched loose powder particles), which may have a hexagonal primary phase and a monoclinic secondary phase. Thus, the ratio of the hexagonal phase content to monoclinic phase content is greater than 1, such as at least 2, for example at least 2 and less than or equal to 20, according to some embodiments. For example, the sintered and quenched LRMO material (e.g., dried active material) may have a superlattice structure including hexagonal primary phase layers separated by interlayers of the monoclinic secondary phase. Alternatively, the sintered and quenched LRMO material may include a hexagonal phase matrix containing monoclinic phase nano-zones (i.e., areas having a width of less than a micron). Mn and Ni may be homogenously distributed within the crystal structure of the LRMO material (e.g., excess Mn, Ni and Li are homogenously and uniformly distributed on the transition metal crystal lattice sites). For example, crystalline particles of the sintered and quenched LRMO material may exhibit a uniform distribution of Mn and Ni atoms throughout the crystalline particles such that there are no regions that are Ni rich or Mn rich when imaged by high-angle annular dark-field (HAADF) energy dispersive X-ray spectrometry (EDS) (i.e., in EDS elemental maps of HAADF tunneling electron microscopy images). In one embodiment, the term “no regions that are Ni rich or Mn rich” in a crystalline particle means that there are no crystalline volumes greater than 3×3×3 nm in the crystalline particle in which there is a greater than 3% difference between ratios of Ni and Mn atoms compared to average ratios of the Ni and Mn atoms in the entire crystalline particle.

The crystal structure of the as-formed active LRMO material may be changed by electrochemical cycling. For example, when the active LRMO material is included as an active material in an electrochemical cell, after a first charge/discharge cycle, the monoclinic phase may no longer be present at detectable levels. It is believed that the monoclinic phase may be consumed during Li ion insertion and/or extraction. As described in more detail below, the methods, conditions, parameters, and/or processing steps described above may, in some embodiments, be applied to the substituted LRMO materials described in this disclosure.

### Thermal Processing Systems

In one aspect, systems for heating materials (e.g., ceramics such as lithium-containing metal oxides) are provided. In some embodiments, the system comprises a furnace. In some embodiments, the furnace is configured such that a material (e.g., a ceramic such as a lithium-containing metal oxide (including the LRMO described above)) may be continuously thermally processed in the furnace (e.g., as opposed to being processed in a batch or semi-batch manner). In some embodiments, the system is a thermal processing system configured to sinter a powder (e.g., comprising the material such as the LRMO material or S-LRMO material) at a sintering temperature.

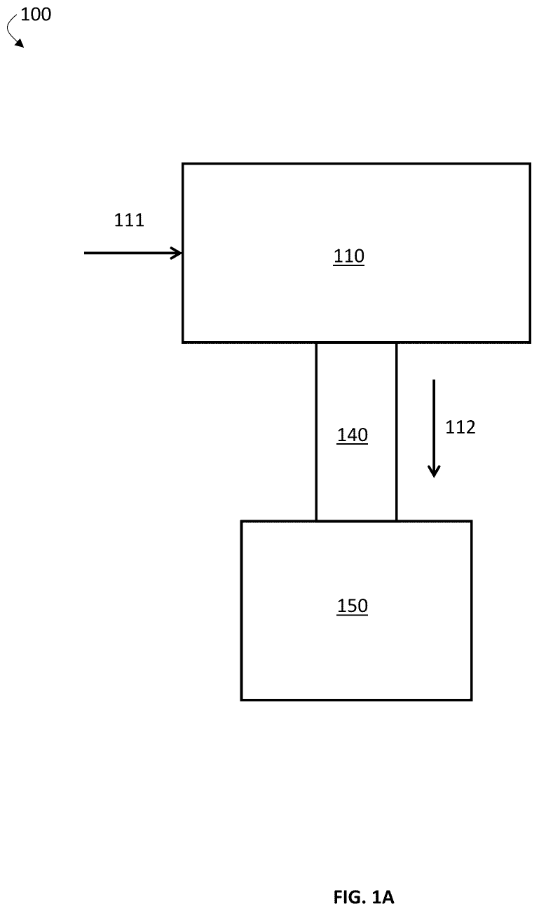

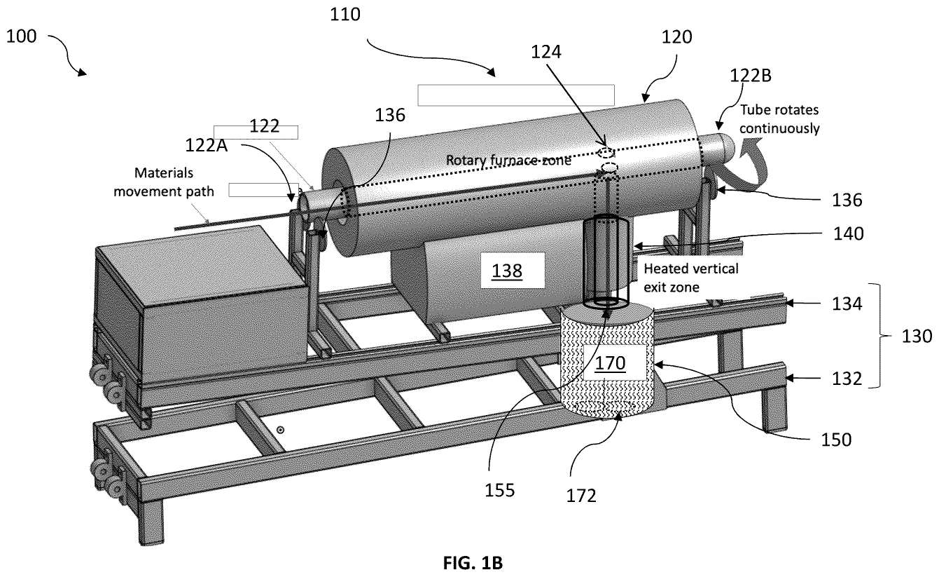

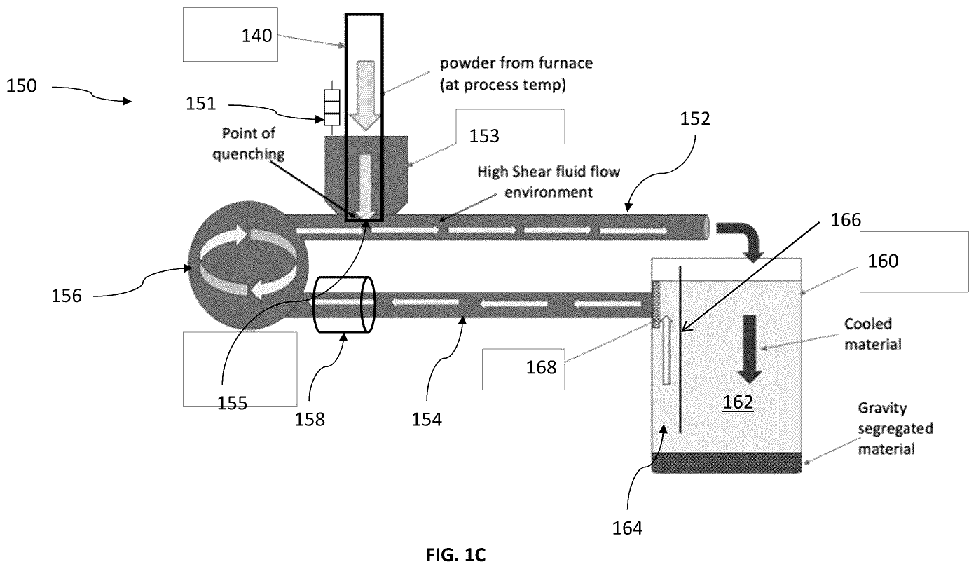

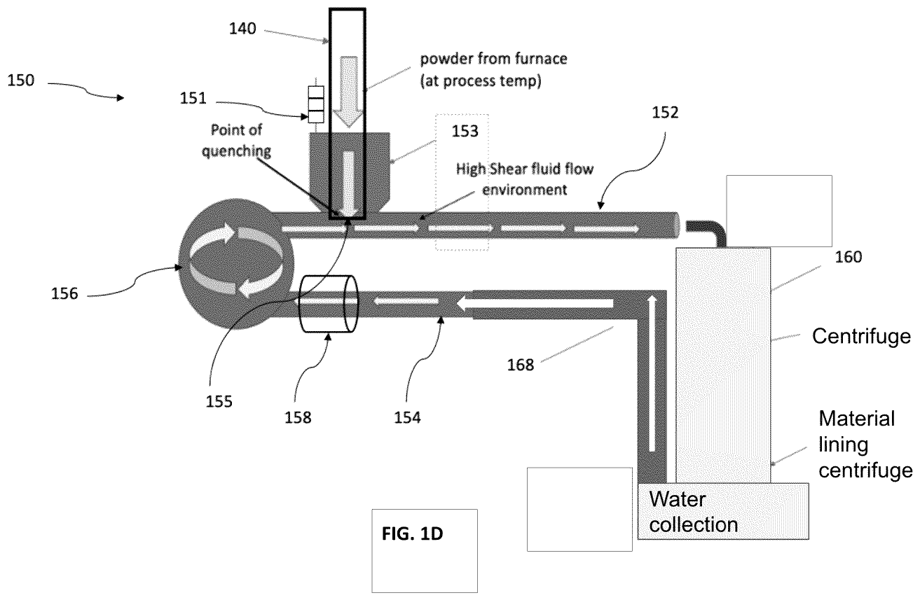

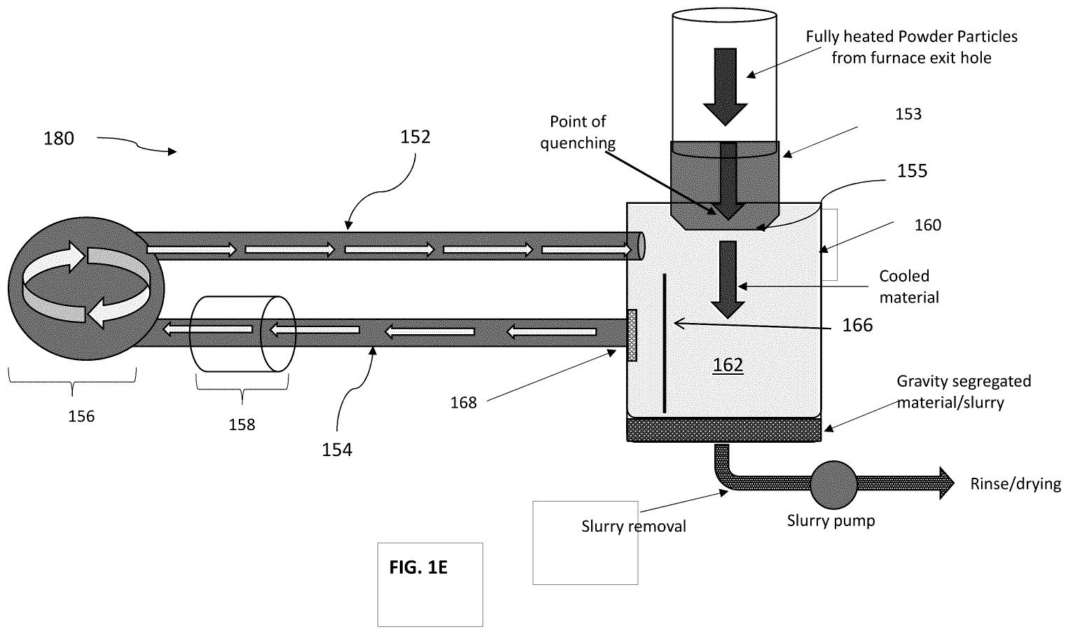

FIG. 1A is a schematic cross-sectional diagram of a thermal processing system 100, according to some embodiments. While thermal processing system 100 is shown in FIG. 1A as including furnace 110 connected to a quenching apparatus 150 via a transfer conduit 140, it should be understood that any of a variety of configurations are possible, and one or more components of system 100 may be substituted for a different component or absent altogether, depending on the embodiment. In some embodiments, a process material powder enters furnace 110 at an input (e.g., represented by arrow 111 in FIG. 111). System 100 may be configured such that at least a portion of the process material powder (e.g., heated at a sintering temperature) may be rapidly transferred from furnace 110 to quenching apparatus 150 (e.g., in a direction represented by arrow 112 in FIG. 1A).

FIG. 1B is a perspective view of a thermal processing system 100, according to some embodiments. Referring to FIGS. 1A-1B, system 100 may be configured to continuously thermally process (e.g., heat and quench) a process material powder, such as a ceramic material powder, for example, the above described LRMO material powder.

In some embodiments, the furnace is a rotary furnace (e.g., a rotary tube furnace). For example, in the embodiment illustrated in FIG. 1B, system 100 comprises a furnace 110 that is a rotary furnace. Such a furnace may facilitate the agitation of at least a portion of the powder being processed (e.g., by rotation of at least a portion of the furnace, which may cause an agitating force (a combination of torque and gravity) to act on the portion of the powder. In some embodiments, the furnace is configured to transport at least a portion of the powder being processed (e.g., to an exit port of the furnace). In some embodiments, an exit port of the furnace is positioned such that heated powder particles exit the furnace at a heated temperature (e.g., sintering temperature) before contacting quenching liquid. For example, in some embodiments, the exit port is in fluidic communication with the quenching liquid. In some embodiments, the exit port is within a hot zone of the furnace. It has been realized in the context of this disclosure that agitating at least a portion of the powder during a least a portion of the time (or all of the time) during which heating (e.g., sintering) is performed may advantageously cause particles of the powder to experience consistent thermal profiles during the heating (e.g., by mixing the particles over time). The agitation of the particles and/or the promotion of each particle experiencing essentially the same thermal profile stands in contrast to typical heating techniques for materials for electrodes, which tend to use static ovens where portions of the material in the interior of a mass of the material may experience different temperatures and/or different durations of heating than portions at the exterior of the mass. The agitation and/or consistent thermal profiles (and in some instances the methods of quenching described throughout), may, in some embodiments, facilitate improved manufacturing scalability and reliability. For example, such a dynamic heating environment may contribute to more homogeneous contact between particulate of the powder with the heat (e.g., with hot gas such as hot oxygenated air) as compared to certain existing system configurations (e.g., with static furnaces).

The furnace may be configured to perform other forms of agitation in addition to or instead of rotation. For example, the furnace may be configured to agitate the powder via vibration. As another example, the furnace may be configured to agitate the powder by forming a fluidized bed of the powder. For example, the furnace may comprise a vessel and a fluid inlet configured to introduce a fluid (e.g., a gas and/or a liquid) into the vessel such that the fluid (e.g., pressurized with a pump) passes through the powder such that the powder particles behave as a fluid (e.g., by rising in suspension).

The furnace (e.g., rotary furnace) may be fluidically connected to a quenching apparatus (e.g., via a transfer conduit). For example, referring again to the embodiments shown in FIGS. 1A-1B, system 100 includes rotary furnace 110, transfer conduit 140, and quenching apparatus 150. Furnace 110 may be configured to heat the at least a portion (e.g., at least 50 wt %, at least 75 wt %, at least 90 wt %, at least 95 wt %, at least 99 wt %, or all) of the material (e.g., a ceramic material such as the LRMO material (or S-LRMO)) to a sintering temperature to form a sintered material (e.g., a sintered ceramic material such as sintered LRMO material (or sintered S-LRMO material)). For example, rotary furnace 110 may be configured to heat the at least a portion (e.g., at least 50 wt %, at least 75 wt %, at least 90 wt %, at least 95 wt %, at least 99 wt %, or all) of the material (e.g., a ceramic material such as the LRMO material) to a sintering temperature to form a sintered material (e.g., a sintered ceramic material such as sintered LRMO material). The heating (e.g., sintering) may be performed as the material is conveyed through at least a portion (or all) of the furnace. For example, in FIG. 1B, material may be heated as it is conveyed through furnace 110 in a direction as shown by the horizontal arrow of FIG. 1B.

The sintering temperature may be any of a variety of values depending on, for example, the chemical composition and/or the physical form of the material (e.g., loose powder versus large solid). In some embodiments, the sintering temperature is a temperature greater than or equal to 800° C. In some embodiments, the sintering temperature is a temperature greater than or equal to 850° C., greater than or equal to 875° C., greater than or equal to 900° C., or greater. In some embodiments, the sintering temperature is less than or equal to 1000° C., less than or equal to 975° C., less than or equal to 950° C., less than or equal to 925° C., less than or equal to 900° C., or less. Combinations of these ranges (e.g., greater than or equal to 850° C. and less than or equal to 1000° C., greater than or equal to 850° C. and less than or equal to 925° C., greater than or equal to 850° C. and less than or equal to 900° C.) are possible. In some embodiments, furnace has multiple temperature zones. The inclusion of multiple temperature zones may permit the furnace to be configured to incrementally increase the temperature of the material (e.g., ceramic such as LRMO) up to the sintering temperature.

In some embodiments, the system is configured to maintain at least a portion of the heated material (e.g., ceramic such as LRMO) at or near the sintering temperature until the heated material reaches the quenching apparatus. For example, in the embodiment in FIG. 1B, system 100 may be configured to maintain heated LRMO material at or near the sintering temperature until the LRMO material reaches quenching apparatus 150 and is quenched. For example, system 100 may be configured such that at least a portion of the heated LRMO material is provided from the furnace 100 into the quenching apparatus 150 at a temperature of at least 800° C. As a more specific example, system 100 may be configured such that at least a portion of the heated powder (e.g., LRMO or S-LRMO material) exits transfer conduit 140 (e.g., and enters quenching apparatus 150) at a temperature within 200° C. (e.g., within 100° C., within 75° C., within 50° C., within 25° C., within 10° C., within 5° C., within 1° C., or less) of the sintering temperature. In some embodiments, system 100 is configured such that at least a portion of the heated powder (e.g., LRMO or S-LRMO material) exits transfer conduit 140 (e.g., and enters quenching apparatus 150) at a temperature of at least 800° C., at least 825° C., or greater. It has been realized in the context of this disclosure that a thermal processing system that can provide a heated powder from a furnace to a quenching apparatus while the powder has undergone relatively little (or no) cooling can improve the quenching efficacy and provide for powders with advantageous properties (such as advantageous crystal structures and/or ion distributions).

In some embodiments, the furnace is a rotary furnace. For example, the furnace may be a rotary kiln type furnace. For example, as shown in FIG. 1B, furnace 110 includes a drum (e.g., shell) 120, a process conduit 122, a support base 130, and a drive motor 138. Drum 120 may be a high temperature tolerant material cylinder configured to heat the process conduit 122. For example, drum 120 may include a gas burner or an electric (i.e., resistive) heating element. Process conduit 122 may comprise a tube (e.g., cylindrical tube) configured to rotate about its longitudinal axis during the operation of furnace 110. Process conduit 122 may have a first end or inlet 122A, an opposing second end 122B, and one or more outlets 124. Inlet 122A may be configured to receive a powdered material, such as the LRMO material powder from a material source or feeder. In some embodiments, the system comprises a continuous material feeder (not shown), such as a screw feeder or the like, configured to provide a steady supply of the material to be heated to an inlet of the furnace (e.g., to supply a steady supply of LRMO material to the inlet 122A). A similar process conduit may also be present in other configurations of the furnace, such as a furnace configured to agitate powder using techniques other than or in addition to rotation, such as vibration and/or fluidization of the powder.

In some, but not necessarily all embodiments, the second end (e.g., second end 122B) is sealed (e.g., capped). Outlets may be located at any of a variety of locations along the process conduit of the furnace at a distance from the inlet of the furnace. For example, in FIG. 1B, outlets 124 may be disposed adjacent to second end 122B. The outlets (e.g., outlets 124) may be through-holes in a sidewall of the process conduit (e.g., process conduit 122) that extend through the sidewall of the an exterior portion of the furnace (e.g., drum 120). For example, in FIG. 1B, outlets 124 may be arranged in an annular pattern around the surface of process conduit 122.

In some embodiments in which the furnace is a rotary furnace (e.g. a rotary kiln type furnace), the process conduit (and in some instances the drum) may be rotated. Rotation of the process conduit may facilitate the material to be continuously mixed and conveyed through the process conduit (e.g., as a loose powder). For example, in FIG. 1B, the process conduit 122 and in some instances drum 120 may be rotated, such that a ceramic material, such as the LRMO material provided to process conduit 122 is continuously mixed and conveyed from the inlet 122A to outlets 124. Outlets 124 may be configured such that the LRMO material drops into transfer conduit 140 and is not conveyed past outlets 124 toward second end 122B of process conduit 122.

In some embodiments, at least a portion (or all) of the process conduit of the furnace is at a non-zero angle with respect to a horizontal direction. In such a way, at least a portion of the furnace may be tilted. In some embodiments, at least a portion (or all) of the process conduit of the furnace is at an angle of greater than or equal to 3 degrees, greater than or equal to 5 degrees, greater than or equal to 10 degrees, greater than or equal to 15 degrees, or greater with respect to a horizontal direction. In some embodiments, at least a portion (or all) of the process conduit of the furnace is at an angle of less than or equal to 30 degrees, less than or equal to 25 degrees, less than or equal to 20 degrees, or less with respect to a horizontal direction. Combinations of these ranges (e.g., greater than or equal to 3 degrees and less than or equal to 30 degrees, greater than or equal to 5 degrees and less than or equal to 20 degrees) are possible. In some embodiments, the horizontal direction corresponds to the direction of the surface (e.g., floor/ground on which the thermal processing system is located).

For example, in FIG. 1B, support base 130 may be configured to support drum 120 and process conduit 122 at a non-zero angle with respect to a horizontal direction. For example, t base 130 may include a lower support 132 and an upper support 134 that may be disposed at a non-zero angle with respect to lower support 132. Upper support 134 may support drive motor 138 and drum 120. In particular, upper support 134 may include gimbals 136 configured to rotatably support the process conduit Drive motor 138 may be configured to rotate drum 120 and thereby rotate process conduit 122.

As noted above, upper support 134 may be connected to the lower support 132 at a non-zero angle, such that process conduit 122 has a negative slope from inlet 122A to outlets 124. In some embodiments, upper support 134 may be adjustably connected to lower support 132, such that the slope of the process conduit 122 is controlled by adjusting the angle between lower support 132 and the upper support 134. In other words, first end 122A of process conduit 122 may be disposed above outlets 124by adjusting the position of upper support 134 relative to the lower support 132. In some embodiments, an angle formed between lower support 132 and upper support 134 is greater than or equal to 3 degrees, greater than or equal to 5 degrees, greater than or equal to 10 degrees, greater than or equal to 15 degrees, or greater. In some embodiments, an angle formed between lower support 132 and upper support 134 is less than or equal to 30 degrees, less than or equal to 25 degrees, less than or equal to 20 degrees, or less. Combinations of these ranges (e.g., greater than or equal to 3 degrees and less than or equal to 30 degrees, greater than or equal to 5 degrees and less than or equal to 20 degrees) are possible. Thus, the process conduit 122 may be tilted at the non-zero angle of 3 degrees to 30 degrees, such as 5 degrees to 20 degrees with respect to the horizontal direction, such that first end 122A is higher than second end 122B. In the alternative, upper support 134 may be fixed to lower support 132 at a set angle.

The slope and/or rotation speed of the process conduit may be controlled in order to control the speed at which the material (e.g., a ceramic powder, such as the LRMO material powder) is conveyed through the furnace. For example, the slope and/or rotation speed of process conduit 122 may be controlled in order to control the speed at which the ceramic powder, such as the LRMO material powder is conveyed through the furnace 110. As such, the material (e.g., a ceramic powder, such as the LRMO material powder) may be uniformly mixed and heated while being moved through the process conduit 122 to the outlets 124 (e.g., at a set speed).

In some embodiments, the process conduit is fluidically connected to a quenching apparatus (e.g., via a transfer conduit). For example, referring again to the embodiment in FIG. 1B, transfer conduit 140 may fluidly connect process conduit 122 to quenching apparatus 150. For example, transfer conduit 140 may be configured to transfer the heated ceramic powder, such as the LRMO material powder received from outlets 124 to the quenching apparatus 150. The transfer conduit may be oriented in a substantially vertical direction (e.g., by having a longitudinal axis within 30 degrees, within 20 degrees, within 10 degrees, within 5 degrees, within 2 degrees, within 1 degree, or less of a vertical direction), such that the material (e.g., a ceramic powder, such as the LRMO material powder) is transported (e.g., falls) from the outlet of the furnace, through the transfer conduit 140, and to the quenching apparatus at least in part (or completely) due to gravitational force.

In some embodiments, the system is configured to provide the material (e.g., the ceramic powder, as the LRMO material) to the quenching apparatus at a relatively high temperature. For example, in some embodiments, the furnace and/or the transfer conduit is configured to provide at least a portion (e.g., at least 50 wt %, at least 75 wt %, at least 90 wt %, at least 95 wt %, at least 99 wt % or all) of the heated material (e.g., the ceramic powder, such as the LRMO material powder) to the quenching apparatus at a temperature that is within 10%, within 5%, within 2%, within 1%, or less of the sintering temperature in the furnace (e.g., in the process conduit 122). For example, in FIG. 1B, the transfer conduit 140 may be configured to limit cooling of and/or maintain the temperature of the received ceramic powder, such as the LRMO material powder.

In some embodiments, the furnace and/or the transfer conduit is configured to provide at least a portion of the material (e.g., a ceramic powder, such as the LRMO material powder) to a quenching apparatus at a temperature greater than or equal to 800° C., greater than or equal to 850° C., greater than or equal to 875° C., greater than or equal to 900° C., or greater. In some embodiments, the furnace and/or the transfer conduit is configured to provide at least a portion of the material (e.g., a ceramic powder, such as the LRMO material powder) to the quenching apparatus at a temperature of less than or equal to 950° C., less than or equal to 925° C., less than or equal to 900° C., or less. Combinations of these ranges (e.g., greater than or equal to 800° C. and less than or equal to 950° C., greater than or equal to 850° C. and less than or equal to 925° C., greater than or equal to 850° C. and less than or equal to 900° C.) are possible.

For example, transfer conduit 140 may be configured to provide the ceramic powder, such as the LRMO material powder to quenching apparatus 150 at a quenching temperature of at least 800° C., such as a temperature ranging from 800° C. to 950° C., or from 850° C. to 925° C., or 900° C. In some embodiments, the transfer conduit comprises a heating element. For example, transfer conduit 140 may include a heating element, such as a resistive or gas heating element, or the like, configured to heat transfer conduit 140, such that ceramic powder, such as the LRMO material powder is maintained between the temperature at which the material is provided to quenching apparatus 150 (the “quenching temperature”) and the sintering temperature. In some embodiments, transfer conduit 140 is at least partially (or completely) covered in thermal insulation to limit cooling of the ceramic powder, such as the LRMO material powder, such that it exits transfer conduit 140 at the quenching temperature.

In some embodiments, the thermal processing system comprises a quenching apparatus. The quenching apparatus may be configured to expose the material being quenched to a high shear and/or turbulence fluid environment. Such a high shear and/or turbulence environment may maintain at least a portion (or all) of the quenched material as a loose powder. For example, the high shear and/or turbulence fluid environment may reduce or eliminate aggregation of powder particulates as the material is quenched, which may improve the rate of quenching in some instances.

The quenching apparatus may comprise a vessel (e.g., a tank, a fluidic circuit, a mass settling apparatus). The quenching apparatus may be configured to rapidly quench the heated material (e.g., heated ceramic powder, such as the sintered LRMO material powder) from the quenching temperature to a lower temperature such as room temperature (e.g., 25° C.). FIGS. 1A-1D show various embodiments of examples of quenching apparatuses.

In some embodiments, the quenching apparatus is configured to quench at least a portion (e.g., at least 50 wt %, at least 75 wt %, at least 90 wt %, at least 95 wt %, at least 99 wt %, or all) of the heated material received (e.g., from the furnace such as via the transfer conduit) in 5 seconds or less, such as in 1 second or less, 500 milliseconds or less, 400 milliseconds or less, 300 milliseconds or less, 200 milliseconds or less, 100 milliseconds or less, or faster. The quenching take at least 100 milliseconds or more to occur. For example, the quenching may occur in from 100 milliseconds to 500 milliseconds from 100 to 400 milliseconds, or from 200 to 300 milliseconds. Accordingly, the quenching apparatus may be configured to quench the at least a portion (e.g., at least 50 wt %, at least 75 wt %, at least 90 wt %, at least 95 wt %, at least 99 wt %, or all) of the heated material (e.g., heated ceramic powder, such as the sintered LRMO material powder particles) at an average rate of at least 50° C./second, at least 87.5° C./second, at least 100° C./second, at least 200° C./second, at least 500° C./second, at least 1000° C./second, at least 1750° C./second, at least 2000° C./second, at least 4375° C./second, at least 5000° C./second, or greater. In some embodiments, the quenching apparatus is configured to quench at least a portion (or all) of the heated material (e.g., heated ceramic powder, such as the sintered LRMO material powder particles) at an average rate of less than or equal to 10000° C./second, less than or equal to 8750° C./second, less than or equal to 5000° C./second, less than or equal to 3000° C./second, or less. Combinations of these ranges (e.g., greater than or equal to 50° C./second and less than or equal to 10000° C./second, greater than or equal to 87.5° C./second and less than or equal to 8750° C./second, greater than or equal to 1750° C./second and less than or equal to 8750° C./second, greater than or equal to 4375° C./second and less than or equal to 8750° C./second,) are possible.

In some embodiments, the quenching apparatus includes a batch apparatus, such as a stirred quench container (e.g., fluid tank) comprising a quench fluid such as water, alcohol, an oil, or the like, and in some instances one or more additives, as discussed above. For example, in FIG. 1B, quenching apparatus 150 includes stirred quench container 170 (e.g., fluid tank). The container may be configured to receive the material (e.g., the ceramic material, such as the sintered LRMO material powder) output from the furnace (e.g., via the transfer conduit). Container 170 may include a mixing or stirring device (e.g., rotating stirrer, etc.) 172 configured to mix the quench fluid in container 170 and/or normalize the temperature of the quench fluid. The quenched material (e.g., the ceramic powder, such as the LRMO material powder) may settle out of the quench fluid at the bottom of the container. In some embodiments, the quenching apparatus includes multiple containers which is substituted for one another when filled with the quenched material (e.g., quenched ceramic powder, such as the LRMO material powder).

In some embodiments, the quenching apparatus is configured to continuously circulate quench fluid. For example, FIG. 1C is a schematic view of a continuous, circulating quenching apparatus 150 that may, in some embodiments, be included in system 100 of FIG. 1B. Referring to FIG. 1C, quenching apparatus 150 is configured to circulate the quench fluid and may include a quench conduit 152, a return conduit 154, a pump 156, and a separator vessel 160. Pump 156 may be configured to pump the quench fluid to and from separator vessel 160 through conduits 152 and 154. Pump 156 may comprise any suitable fluid (e.g., liquid) pump. In particular, pump 156 may be configured to generate a high shear and/or high turbulence fluid flow environment within quench conduit 152. In some embodiments, pump 156 includes an inline cooler configured to cool the quench fluid. In some embodiments, the quenching apparatus 150 includes a separate fluid cooler 158, such as a heat exchanger, configured to cool the quench fluid. In some embodiments, fluid cooler 158 is located on return conduit 154. In some embodiments, fluid cooler 158 comprises a filter.

Quench conduit 152 may be configured to receive the heated material (e.g., heated ceramic powder, such as the LRMO material powder from the transfer conduit 140). Transfer conduit 140 may include a heater 151 and thermal insulation. In some embodiments, material (e.g., the ceramic powder, such as the LRMO material powder) may be transported (e.g., dropped) from the transfer conduit into the quench fluid in the quench conduit at least in part due to the force of gravity. Quenching apparatus 150 may include a splash sleeve 153 to control the quench fluid splashing, as the material (e.g., the ceramic powder, such as the LRMO material powder) enters the quench fluid. Splash sleeve 153 may form an air seal. In other words, the bottom end of transfer conduit 140 containing the outlet opening may be immersed into the quench fluid in quench conduit 152. Splash sleeve 153 may surround at least a portion (or all) of the bottom end of transfer conduit 140 to protect the bottom end of the transfer conduit from the environment, such that an air seal is provided to reduce or eliminate cool airflow from the outside onto or into the bottom end of the transfer conduit 140. Splash sleeve 153 may also form a part of the thermal insulation or may be separate from the thermal insulation. The quenching apparatus may be configured such that the heated material (e.g., heated ceramic powder, such as the LRMO material powder) is rapidly submerged in the quenching fluid after entering the quenching conduit.

The high shear and/or turbulence of the quench fluid may be configured to increase quenching uniformity. For example, the high shear or turbulence of the quench fluid may be configured to increase quench rate uniformity of the ceramic powder, such as the LRMO material powder.

The separator vessel of the quenching apparatus may be a container (e.g., fluid tank) that is divided into a settlement compartment and a return compartment. For example, referring again to FIG. 1C, separator vessel 160 may be a container (e.g., fluid tank) that is divided into a settlement compartment 162 and a return compartment 164 by a divider (e.g., a wall) 166 which extends from the top to a middle portion of separator vessel 160, but does not extend all the way to the bottom interior surface of separator vessel 160. The quench fluid and quenched material (e.g., the ceramic powder, such as the LRMO material powder) may be provided to the top of the settlement compartment by the quench conduit. The material may be gravity separated and settle out of the quench liquid and collect at the bottom surface of the separator vessel (e.g., below the divider 166).

In some embodiments, the system is configured to further dry collected powder (e.g., powder collected from the settlement compartment. For example, the system may further comprises a desiccator. In some embodiments, the desiccator is configured to operate at a reduced pressure relative to ambient pressure. For example, the desiccator may be a vacuum desiccator. It has been realized in the context of this disclosure that such additional drying (e.g., with a desiccator such as a vacuum desiccator) may promote improved powder drying, which may result in improved performance characteristics of the resulting materials.

In the embodiment shown in FIG. 1C, the quench fluid may then flow into return compartment 164 and be provided to return conduit 154 by pump 156. In some embodiments, separator vessel 160 may include an optional filter 168 to prevent unsettled material powder (e.g., ceramic powder, such as the LRMO material powder) remaining in the quench fluid from entering return conduit 154.

In some embodiments, the separator vessel comprises or is fluidically connected to a centrifuge. The centrifuge may be a batch centrifuge or a continuous centrifuge. For example, FIG. 1D shows a schematic illustration of an embodiment in which quenching apparatus 150 comprises separator vessel 160 comprising a centrifuge, according to some embodiments. In the embodiment shown in FIG. 1D, the quench fluid is directed into a continuously rotating centrifuge. In some instances, the centrifuge uses a filtration media of less than 10 microns and preferably 0.5 microns. The material may be separated from the quench fluid and ejected into a catch tank that then is recirculated and reconditioned.

In some embodiments, the heated powder particles are added directly to separator vessel 160 (e.g., inlet 155 is in direct fluidic communication with the centrifuge). For example, as illustrated in FIG. 1E, exemplary quenching apparatus 180 comprises splash sleeve 153 configured to receive powder particles (e.g., heated powder particles from a furnace outlet). In some embodiments, inlet 155 is in direct fluidic communication with separator vessel 160 (e.g., such that the powder particles enter separator vessel 160 directly via inlet 155). In some such embodiments, the point of quenching occurs proximate inlet 155 at the separator vessel 160. Quenching apparatus 180 is configured, in some embodiments, to circulate the quench fluid and may include quench conduit 152, return conduit 154, pump 156, and/or separator vessel 160. Pump 156 may be configured to pump the quench fluid to and from separator vessel 160 through conduits 152 and 154. Optional filter 168 may be present (e.g., in conduit 154). In some embodiments, quenching apparatus 180 further comprises fluid cooler 158.

In some embodiments, for example in the context of the embodiments illustrated in FIGS. 1B-1E, gravity segregated material/slurry may be collected and removed from the quenching apparatus (e.g., for subsequent processing such as rinsing and/or drying). In some embodiments, a slurry pump is in fluidic communication with separator vessel 160 (e.g., configured to facilitate removal of the gravity segregated material/slurry). In some embodiments, the slurry (e.g., comprising the quenched particles/powder) is a flowable slurry.

Advantageously, in some embodiments the continuous, circulating quench fluid flow allows for scale-up of the powder processing and for continuously exposing the sintered material powder to a uniform quench environment. Such flow can be especially advantageous if an acid or another additive that modifies the surface of the powder particles is added to a water quench fluid. The circulating quench fluid flow may advantageously provide a more even mixing of the additive in the water.

While the system has, in some portions of the disclosure above, been described with respect to thermally processing the LRMO material, the system is not so limited, and may be used to thermally process any of a variety materials (e.g., powder materials), such as ceramic powders, that are conveyed through the system. For example, in various embodiments, the sintering and/or quenching temperatures of system 100 may be modified based on the sintering temperature of a particular sintered material. In particular, the sintering temperature may be higher or lower than the LRMO material sintering temperature. The quenching temperature of the sintered material in transfer conduit 140 may be adjusted accordingly. For example, transfer conduit 140 may be configured to transfer the sintered material to the quenching apparatus 150 at a quenching temperature that ranges from 0° C. to 200° C. less than the sintering temperature, such as a quenching temperature ranging from 0° C. to 175° C., from 0° C. to 150° C., from 0° C. to 100° C., or from 0° C. to 75° C. less than the sintering temperature.

In some embodiments, a thermal processing system of FIGS. 1A-1D includes a furnace 110 configured to sinter a powder at a sintering temperature. The system may further comprise a quenching apparatus 150 configured to quench at least a portion of the sintered powder in a quench fluid. The system may further comprise a transfer conduit 140 configured to provide at least a portion of sintered powder having the sintering temperature from the furnace 110 to the quenching apparatus 150. The system may be configured to provide the at least a portion of sintered powder from furnace 110 to quenching apparatus 150 in 500 ms or less (e.g., 200 ms or less, 100 ms or less, and/or as low as 50 ms or less.

In some embodiments, a thermal processing system of FIG. 1B includes a tilted rotary furnace 110 configured to sinter a powder at a sintering temperature; a quenching apparatus 150 configured to quench at least a portion of the sintered powder in a quench fluid; and a transfer conduit 140 configured to provide at least a portion of sintered powder having the sintering temperature from the tilted rotary furnace 110 to the quenching apparatus 150 in 500 ms or less.

In the embodiment shown in FIG. 1B, the quenching apparatus 150 is located below the tilted rotary furnace 110, and the transfer conduit 140 comprises a substantially vertical tube connecting at least one outlet 124 of the titled rotary furnace 110 to an inlet 155 of the quenching apparatus 150. In some embodiments, the vertical tube is hermetically sealed. The transfer conduit 140 may be configured to provide at least a portion of the sintered powder from the tilted rotary furnace 110 to the quenching apparatus 150 at least in part by a force of gravity.

In some embodiments, transfer conduit 140 is configured to provide at least a portion of the sintered powder having the sintering temperature from furnace 110 into the quenching apparatus 150 at a quenching temperature that is less than the sintering temperature by a value of greater than or equal to 0° C. and less than or equal to 200° C. In some such embodiments, the quenching apparatus is configured to quench the powder from the quenching temperature to a temperature that is in the range of greater than or equal to 10° C., greater than or equal to 15° C., greater than or equal to 20° C. and/or less than or equal to 120° C., less than or equal to 100° C., less than or equal to 80° C., less than or equal to 60° C., less than or equal to 50° C., less than or equal to 45° C., less than or equal to 40° C., less than or equal to 35° C., less than or equal to 30° C., less than or equal to 25° C., or less. Other ranges are also possible. The system may be configured such that the quenching occurs in 500 ms or less (e.g., 200 ms or less, and/or as low as 100 ms or less).

For example, in some embodiments, powder particles may be heated (e.g., to a sintering temperature in a furnace) and/or agitated (e.g., during the heating) as described herein. In some embodiments, at least a portion of the particles having the heated temperature (e.g., a sintering temperature) is provided from the furnace (e.g., at least in part by the force of gravity) through a transfer conduit (e.g., having an inlet) into a quenching fluid in a quenching apparatus as described herein within 200 ms or less (e.g., 100 ms or less).

In some embodiments, the transfer conduit 140 is configured to provide at least a portion of the sintered powder having the sintering temperature from the tilted rotary furnace 110 into the quenching apparatus 150 at a quenching temperature that is less than the sintering temperature by a value of greater than or equal to 0° C. and less than or equal to 200° C., and the quenching apparatus is configured to quench the powder from the quenching temperature to room temperature in 500 ms or less. In some embodiments, the transfer conduit comprises thermal insulation (e.g., the sleeve 153 or additional insulation) configured to limit cooling of the powder and a heater 151 configured to heat the transfer conduit 140 to at least the quenching temperature. The heater 151 may be embedded in the thermal insulation 153. In one embodiment, the sintering temperature ranges from 800° C. to 1000° C.; the quenching temperature is least 800° C.; and the powder comprises a lithium-rich metal oxide (LRMO) material powder and/or an S-LRMO. In one embodiment, the sintering temperature ranges from 850° C. to 1000° C.; the quenching temperature is least 800° C.; and the powder comprises a lithium-rich metal oxide (LRMO) material powder.

In some embodiments, at least a portion of the transfer conduit 140 extends into the quenching apparatus 150 to form an air seal with the quench fluid in the quenching apparatus 150. For example, the lower end of the transfer conduit may extend into the quench fluid located in the container 170 in FIG. 1B or flowing through the quench conduit 152 in FIG. 1C. In the embodiment of FIG. 1B, the quenching apparatus 150 comprises a vessel 170 containing a stirrer 172 and configured to hold the quench fluid. In the embodiment of FIG. 1C, the quenching apparatus 150 comprises a continuous liquid loop quenching apparatus. The continuous liquid loop quenching apparatus comprises a quench conduit 152 configured to receive at least a portion of the powder from the transfer conduit 140 and quench at least a portion of the powder in the quench fluid; a separator vessel 160 configured to separate at least a portion of the quenched powder from the quench fluid; a pump 156 configured to pump the quench fluid through the quench conduit 152; and a return conduit 154 configured to provide the quench fluid from the separator vessel 160 to the pump 156.

In some embodiments, the continuous liquid loop quenching apparatus 150 comprises a quench conduit 152 configured to receive the at least a portion of the powder from the transfer conduit 140 and quench at least a portion of the powder in the quench fluid; separator vessel 160 comprising a batch or continuous centrifuge configured to receive at least a portion of the quenched powder and quench fluid, wherein the centrifuge is configured to separate at least a portion of the quenched powder and send the quench fluid to be collected in a holding vessel configured to pump at least a portion of the quench fluid back to the quench conduit; pump 156 configured to pump the quench fluid through the quench conduit; and return conduit 154 configured to provide the quench fluid from the centrifuge holding vessel to pump 156.

In one embodiment shown in FIG. 1B, the tilted rotary furnace 110 comprises a process conduit 122 comprising an inlet 122A and an outlet 124, the process conduit configured to convey a powder through the rotary furnace 110; a drum 120 housing the process conduit 122 and configured to heat the process conduit 122 to the sintering temperature; a motor 138 configured to rotate at least the process conduit 122; and a base 130 which supports the drum 120 at a non-zero angle with respect to a horizontal direction, such that the inlet 122A of the process conduit 122 is higher than the outlet 124 of the process conduit 122 which is fluidly connected to an inlet of the transfer conduit 140. The outlet 124 of the process conduit 122 may comprise multiple openings arranged in an annular pattern around a sidewall of the process conduit 122 and that extend through a sidewall of the drum 120 to the inlet of the transfer conduit 140.

### Rapid Precursor Decomposition

LRMO materials may be formed from various precursor materials. For example, precursor materials may be metalloorganic compounds comprising a metal, such as Li, Mn, and/or Ni, and a solubilizing agent, such as an organic ligand. For example, precursor materials may include metal acetates, metal carbonates, metal nitrates, metal sulfates, and/or metal hydroxides.

In various embodiments, LRMO materials may be formed by thermally decomposing a precursor material followed by sintering and quenching the resulting thermally decomposed LRMO material. The precursor material may comprise a gel formed via a sol-gel process. The gel may comprise a nonfluid network of material (e.g., a colloidal network or polymer network) having a relatively small yield stress and that is expanded throughout its whole volume by a fluid (e.g., a liquid such as water). A gel may contain a network formed by covalent bonds or via other mechanisms such as physical aggregation. A sol-gel process may involve converting monomers into a colloidal solution (a sol) that can serve as a precursor for a resulting gel (e.g., of discrete particles or network polymers). The present inventors have determined that rapidly decomposing a precursor material gel may improve the homogeneity of LRMO materials. For example, in a sol part of the sol-gel process, stoichiometric amounts of Li, Mn, and Ni-containing precursors may be mixed with water to form an aqueous mixture. For example, stoichiometric amounts of Li(CH₃COO)*2H₂O, Mn(CH₃COO)₂*4H₂O, and Ni(NO₃)₂*6H₂O, may be mixed to form the aqueous mixture. However, the present disclosure is not limited to any particular precursor materials. For example, in some embodiments, all acetate precursors or all nitrate precursors (i.e., lithium, manganese and nickel nitrates) may be used. In some embodiments, the mixture may comprise a greater than or equal to 0.01 and less than or equal to 0.20 molar fractional excess of the lithium acetate precursor to compensate for lithium loss during processing. Other ranges are also possible.

The mixture may then be heated to form the precursor gel. For example, the mixture may be heated at a temperature of greater than or equal to 90° C. and less than or equal to 150° C., such as 100° C., for a time period sufficient for gelation to occur. Other ranges are also possible.

The gel may then be thermally decomposed. For example, the gel may be heated at a temperature and for a time period sufficient to extract (e.g., volatize and/or decompose) solubilizing agents, such as organic ligands and/or solvents of the gel and form a thermally decomposed LRMO material.

The thermal decomposition may be performed using a conventional furnace, such as a muffle box and/or tube furnace. However, such devices generally have slow heating and cooling rates on the order of greater than or equal to 1 and less than or equal to 10° C. per minute, and do not employ any type of direct radiation thermal energy input. As such, conventional furnaces may require at least 8 hours of processing time and a significant amount of energy to form the thermally decomposed LRMO material.

According to various embodiments, rapid (e.g., high rate) heating methods are used to form a thermally decomposed LRMO material. For example, an embodiment may utilize microwave radiation to thermally process LRMO precursor materials (i.e., to rapidly decompose LRMO precursors, such as the gel precursors formed via a sol-gel process). For example, the microwave radiation may be direct microwave radiation. Other suitable type of heating for at least some embodiments include, but are not limited to, convection heating and/or radiative heating. Combinations of heating methods may be used. For example, the thermal decomposition may involve convection heating, microwave radiation (e.g., direct microwave radiation), and/or radiative heating.

Microwaves are defined as electromagnetic radiation with wavelengths of greater than or equal to 1 mm and less than or equal to 1 m. The widely adopted domestic microwave ovens use microwave radiation with frequency around 2.45 GHz. Regulations have restricted the microwave frequencies that may be used for domestic and industrial applications. The mechanisms of microwave heating are believed to be attributed into two categories: 1) the flow of current under the external electric field generated by microwave radiation generates heat due to ohmic effect; and 2) dipoles that exist in ceramic re-orientate themselves under a changing electric field generate heat due to frictions.

Microwave heating may allow for lower thermal processing (e.g., precursor thermal decomposition) temperatures. Microwave heating may also allow for shorter heating times, due to very rapid local heating, as compared to conventional furnace heating processes. The intimate mixing of precursor materials may also allow for more efficient volumetric heating than conventional furnace heating processes.

In some embodiments, microwave heating is used to heat and decompose precursor materials and form thermally decomposed LRMO materials. For example, the precursor materials may include ligands and/or metals that are highly susceptible to microwave radiation. As such, various embodiments utilize microwave radiation in order to heat precursors and/or precursor gels to very high temperatures in very short periods of time. It has also been found that microwave heating may also provide highly uniform heat dispersion. As such, without wishing to be bound by theory, employing microwave radiation can advantageously and dramatically change the rate of heating and the resulting thermally decomposed LRMO material organization and/or structure. For example, microwave heating of a precursor gel may result in a highly homogenous thermally decomposed LRMO material. The thermally decomposed LRMO material may be in a form of an inorganic ash that is devoid of organic components (e.g., contains no carbon or an unavoidable amount of carbon). As such, microwave heating may allow for thermally decomposed LRMO materials to be formed without the need for a separate furnace firing, which may be omitted.

For example, a precursor gel may be provided to a microwave furnace, where microwave radiation is used to decompose the gel and form the thermally decomposed LRMO material. For example, microwave radiation may be used to heat the gel to a temperature of at least 350° C., such as a temperature of greater than or equal to 350° C. and less than or equal to 500° C., for a time period sufficient to volatilize the ligands and/or solvents of the gel and form the thermally decomposed LRMO material (e.g., LRMO inorganic ash). Other ranges are also possible. In various embodiments, the thermally decomposed LRMO material may be formed in 30 minutes or less, such as in a time period of greater than or equal to 15 and less than or equal to 30 minutes, using a continuous or pulsed microwave having power level of 20,000 W per kg of microwaved material, or less. Other ranges are also possible. Accordingly, the microwave-based heating process may be configured to rapidly remove (e.g., vaporize and/or combust) organic components from precursor species in order to form the thermally decomposed LRMO material having improved structural characteristics, such as homogenous cation and/or metal oxide distribution.

While microwave thermal decomposition of precursor gel formed by the sol-gel process is described above, in other embodiments, the precursors that are thermally decomposed by microwaves may be formed by other methods. For example, alternative precursor preparation methods may include a mechanical milling/mixing method, a freeze-drying rotary evaporation, or a co-precipitation method. Another example of an alternative precursor preparation method is the use of static a convection oven. In one embodiment of co-precipitation a method, co-precipitated precursors comprising hydroxides of Mn and Ni is mixed with lithium and/or other alkaline or alkali carbonates and/or or hydroxides. The resulting mixture may be mixed completely and thermally processed. In one embodiment of a co-precipitation method, precursors comprising hydroxides of Mn and Ni may be mixed with lithium carbonate and co-precipitated. For example, solid state precursor materials including Li₂CO₃ or LiOH, nickel oxide, and manganese oxide may also be used. Such solid state precursors may also have an excess of Li-containing precursor (e.g., lithium carbonate or hydroxide) of a greater than or equal to 0.01 and less than or equal to 0.20 molar fractional excess to overcome losses in lithium content during processing. The precursors prepared by any of these methods may also be subjected to the microwave thermal decomposition to form the thermally decomposed LRMO material (i.e., the LRMO inorganic ash). As described in more detail below, the methods, conditions, parameters, and/or processing steps described above may, in some embodiments, be applied to the substituted LRMO materials described in this disclosure.

The thermally decomposed LRMO material (i.e., the LRMO inorganic ash) may then be mixed and ground (e.g., milled) to form a precursor LRMO powder. The precursor LRMO powder may then be thermally processed (e.g., sintered) in any suitable thermal processing apparatus, such as in a furnace, such as a tube furnace, muffle box, etc., to form a sintered LRMO material. For example, the precursor LRMO powder material may be heated (e.g., sintered) at the thermal processing temperature (e.g., a temperature of at least 800° C., such as 900° C.), for a time period of greater than or equal to 12 and less than or equal to 24 hours, and then the sintered LRMO material may be rapidly or ultra-rapidly quenched as described above to form the quenched LRMO material. The quenched LRMO material may then be dried and optionally reground (e.g., milled) into a LRMO active material (e.g., active cathode material powder). This LRMO active cathode material powder may then be mixed with a binder or other inactive cathode material to form a cathode of a Li-ion battery.

According to various embodiments, methods of forming LRMO materials may include a combination of rapid heating, such as microwave heating, for at least a part of the thermal processing, combined with rapid or ultra-rapid quenching, in order to produce LRMO materials having unexpectedly high performance. Specifically, this process may advantageously produce LRMO material having a high degree of atom/cation disorder/homogeneity (which can be quantified using X-ray diffraction), along with no or substantially no surface segregation of nickel or nickel oxide in the particles (e.g., crystallites), which can be observed using transmission electron microscopy. The combination of these material attributes produces cathode active materials that exhibit little to no capacity fade over 100's to 1000's of charge/discharge cycles, a substantially reduced or eliminated loss in average discharge voltage during cycling, and rate capabilities that are suitable for commercial use.

According to various embodiments, the embodiment methods which include microwave heating and/or rapid/ultra-rapid quenching step, may be used to form LRMO active materials that do not suffer from the chemical instability of LRMO materials prepared differently. In particular, the rapid or ultra-rapid quenching step may be used to form LRMO active materials having reduced Ni surface segregation and increased structural homogeneity, as compared to conventional LRMO materials which are slow cooled after sintering. In various embodiments, the above microwave heating process may be used in conjunction with rapid or ultra-rapid quenching to form LRMO active materials. For example, thermally decomposed LRMO materials formed using microwave decomposition may be sintered and then subjected to the rapid or ultra-rapid quenching process. As described in more detail below, the methods, conditions, parameters, and/or processing steps described above may, in some embodiments, be applied to the substituted LRMO materials described in this disclosure.

In one embodiment, a cathode electrode (i.e., positive electrode) includes a LRMO active material comprising a powder embedded in a binder. The powder may have an average particle/agglomerate size of greater than or equal to 0.1 μm and less than or equal to 10 μm and an average crystal (i.e., crystallite) size of greater than or equal to 25 nm and less than or equal to 500 nm. The powder (e.g., embedded in a binder) may comprise particles having an average largest cross-sectional dimension of greater than or equal to 0.1 micron, greater than or equal to 0.2 microns, greater than or equal to 0.5 microns, greater than or equal to 1 micron or greater. The powder (e.g., embedded in a binder) may comprise particles having an average largest cross-sectional dimension of less than or equal to 10 microns, less than or equal to 5 microns, less than or equal to 2 microns, or less. Combinations of these ranges (e.g., greater than or equal to 0.1 micron and less than or equal to 10 microns) are possible. Other ranges are also possible. The powder may have crystals (e.g., crystallites) having an average largest cross-sectional dimension of greater than or equal to 25 nm, greater than or equal to 50 nm, greater than or equal to 100 nm, greater than or equal to 150 nm, or greater. The powder may have crystals (e.g., crystallites) having an average largest cross-sectional dimension of less than or equal to 500 nm, less than or equal to 300 nm, less than or equal to 200 nm, or less. Combinations of these ranges (e.g., greater than or equal to 25 nm and less than or equal to 500 nm) are possible. Other ranges are also possible. In one embodiment, the particles of the LRMO active material powder may have at least one of a spinel surface layer, a carbon coating (e.g., resulting from the carbohydrate additive in the quench bath) and/or passivated oxygen bonds on a surface (e.g., resulting from the acid additive in the quench bath). The cathode electrode may be included in a battery, such as a lithium-ion battery, that also includes an anode electrode (i.e., a negative electrode), an electrolyte and a separator.

In one embodiment, the cathode electrode active material may be represented by a chemical formula Liₓ(Mn_{y}Ni_{1-y})₂₋ₓO₂, where x is greater than 1.05 and less than 1.25, and y is less than or equal to 0.95 and greater than or equal to 0.1. The active material may comprise layered hexagonal (e.g., rhombohedral) and monoclinic phases at least prior to first electrochemically cycling a battery containing the cathode electrode. The active material may exhibit at least one of (i) a (106)+(102):(101) x-ray diffraction peak intensity ratio of greater than or equal to 0.32, such as greater than or equal to 0.33 and less than or equal to 0.346; and/or (ii), a (003) to (104) x-ray diffraction peak ratio of greater than 2, such as greater than or equal to 2.01 and less than or equal to 2.575; and/or (iii) delivery of at least 200 mAh/g, such as at least 200 and less than or equal to 230 mAh/g, specific capacity on first discharge (e.g., at C/2 rate) when the cathode electrode is included in a lithium-ion battery; and/or (iv) the lithium-ion battery exhibits less than 10% loss in average discharge voltage at a C/20 rate after 100 charge/discharge cycles when the cathode electrode is included in the lithium-ion battery; and/or (v) less than 10%, such as less than 5% capacity fade (e.g., greater than or equal to 0 and less than or equal to 4% capacity fade or an increase in capacity) over at least 100 charge/discharge cycles, such as over 200 C/5 charge/discharge cycles, when included in the positive electrode of the lithium-ion battery. In one embodiment, the lithium-ion battery may include lithium or graphite as the anode electrode.

In one embodiment, an average discharge voltage of the battery (e.g., lithium-ion battery) does not decrease more than 5% (e.g., greater than or equal to 0 and less than or equal to 4%) over 50 C/20 (charge)−C/2 (discharge) charge/discharge cycles; and/or a discharge capacity of the battery is greater than 80% of its original capacity after 800 C/20-C/2 charge/discharge cycles.

### Substituted LRMO Materials

In one aspect, a substituted lithium-rich metal oxide (S-LRMO) material, in which at least a portion of the lithium is substituted with sodium, potassium, calcium and/or magnesium, is provided. According to various embodiments, cathode active materials comprise a substituted lithium-rich metal oxide (S-LRMO) material, in which at least a portion of the lithium is substituted with sodium, potassium, calcium and/or magnesium. Herein, the S-LRMO material may also be referred to as a substituted alkali/alkaline—atom rich metal oxide (ARMO) material. The S-LRMO material may have the general formula:

Li[LiₓA_{y}M_{z}]O_{b},

wherein A is at least one alkaline earth element and/or alkali element other than lithium, and (x+y) is greater than 0 and less than 0.3, y>0.05, and z=1−(x+y), M comprises manganese (Mn) and nickel (Ni), b is greater than or equal to 1.8 and less than or equal to 2.2 depending on the net oxidation state of M.

In some embodiments, A is an alkaline earth element such as beryllium, magnesium, calcium, strontium, barium, and radium. In some embodiments, A is an alkali element other than Lithium such as sodium, potassium, rubidium, cesium, and francium. In an exemplary set of embodiments, A is selected from the group consisting of Na, K, Ca, and/or Mg.

In some embodiments, the S-LRMO material has the general formula:

Li[LiₓA_{y}M_{z}]O_{b},

wherein A is at least one alkaline earth element and/or alkali element other than lithium, such as Na, K, Ca, and/or Mg, and (x+y) is greater than or equal to 0 and less than or equal to 0.3, y>0.05, and z=1−(x+y), M is a combination of transition metals and comprises at least manganese (Mn) and nickel (Ni), b is greater than or equal to 1.8 and less than or equal to 2.2 depending on the net oxidation state of M. Preferably, b=2. In one embodiment, (x+y) is greater than 0.1 and less than 0.25, such as 0.2, and y is greater than or equal to 0.05 and less than or equal to 0.15, such as greater than or equal to 0.06 and less than or equal to 0.14. In one embodiment, the material exhibits the crystallinity and phase content commonly found in lithium-rich layered metal oxides (i.e., in the non-substituted LRMO material embodiment) with no evidence of other crystalline phases. In one embodiment, the S-LRMO material in its pristine state (e.g., before it is charged for the first time), may have distinct hexagonal (e.g., rhombohedral) and monoclinic phases. In some embodiments, the two phases may be disposed in a layered structure. Those of ordinary skill in the art would understand, based upon the teachings of this specification, that the stoichiometry “O₂” in a chemical formula for the LRMO and/or S-LRMO is not intended to be limited to an exact chemical stoichiometry and that the actual elemental amount of oxygen may vary slightly (e.g., from greater than or equal to 1.9 to less than or equal to 2.1 moles of oxygen per unit mole active material) e.g., to accommodate slight variations in the average transition metal oxidation states of other components of the material (e.g., transition metal oxidation states). For example, M may comprise 50 to 80 atomic percent Mn, 20 to 50 atomic percent Ni, and greater than or equal to 0 and less than or equal to 10 atomic percent other elements including, for example, Ti, Al, Fe, Co, or any combination thereof. In various embodiments, up to 20% of the total Li content in the material may be substituted with one or more alkali elements other than Li and/or one or more alkaline earth elements. For example, greater than or equal to 0.5%, greater than or equal to 1%, greater than or equal to 2%, greater than or equal to 5%, greater than or equal to 10%, or more of the Li may be substituted with at least one of Na, K, Mg, and Ca. In some embodiments, up to 13%, up to 15%, up to 20%, or more of the Li may be substituted with at least one of Na, K, Mg, and Ca. For example, greater than or equal to 0.5% and less than or equal to 20%, such as greater than or equal to 1% and less than or equal to 15%, or greater than or equal to 2% and less than or equal to 13% of the Li may be substituted with at least one of Na, K, Mg and Ca. Thus, an atomic ratio of A to lithium in the above formula may be greater than or equal to 0.5:95.5 and less than or equal to 20:80. In other words, the ratio of A to (1+x) in the above formula may be greater than or equal to 0.5:95.5 and less than or equal to 20. Other ranges are also possible. When thermally processed as described above (e.g., sintered and rapidly quenched), the S-LRMO has a classical lithium-rich crystalline structure that exhibits some combination of trigonal (R-3m) and monoclinic (C2/m) crystal structure features, and no obvious secondary phases. In other words, S-LRMO includes both the hexagonal phase and the monoclinic phase, where the trigonal crystal system is a species of the hexagonal crystal family (i.e., genus).

In some embodiments, greater than or equal to 0.5%, greater than or equal to 1%, greater than or equal to 2%, greater than or equal to 5%, greater than or equal to 10%, or more of the Li is substituted with Na. In some embodiments, up to 13%, up to 15%, up to 20%, or more of the Li is substituted with Na. For example, greater than or equal to 0.5% and less than or equal to 20%, such as greater than or equal to 1% and less than or equal to 15%, or greater than or equal to 2% and less than or equal to 13% of the Li may be substituted with Na. Other ranges are also possible.

In some embodiments, greater than or equal to 0.5%, greater than or equal to 1%, greater than or equal to 2%, greater than or equal to 5%, greater than or equal to 10%, or more of the Li is substituted with K. In some embodiments, up to 13%, up to 15%, up to 20%, or more of the Li is substituted with K. For example, greater than or equal to 0.5% and less than or equal to 20%, such as greater than or equal to 1% and less than or equal to 15%, or greater than or equal to 2% and less than or equal to 13% of the Li may be substituted with K. Other ranges are also possible.

In some embodiments, greater than or equal to 0.5%, greater than or equal to 1%, greater than or equal to 2%, greater than or equal to 5%, greater than or equal to 10%, or more of the Li is substituted with Mg. In some embodiments, up to 13%, up to 15%, up to 20%, or more of the Li is substituted with Mg. For example, greater than or equal to 0.5% and less than or equal to 20%, such as greater than or equal to 1% and less than or equal to 15%, or greater than or equal to 2% and less than or equal to 13% of the Li may be substituted with Mg. Other ranges are also possible.

In some embodiments, greater than or equal to 0.5%, greater than or equal to 1%, greater than or equal to 2%, greater than or equal to 5%, greater than or equal to 10%, or more of the Li is substituted with Ca. In some embodiments, up to 13%, up to 15%, up to 20%, or more of the Li is substituted with Ca. For example, greater than or equal to 0.5% and less than or equal to 20%, such as greater than or equal to 1% and less than or equal to 15%, or greater than or equal to 2% and less than or equal to 13% of the Li may be substituted with Ca. Other ranges are also possible.

In some embodiments, the S-LRMO material (e.g., as a cathode active material) is represented by the formula Li[LiₑA_{f}M_{g}]Oₕ, wherein: e is less than or equal to 0.06, f is 0.14 or more, g=1−(e+f), A comprises at least one of Na, K, Ca or Mg, M comprises Mn and Ni, and h is greater than or equal to 1.8 and less than or equal to 2.2. Other ranges are also possible.

In some embodiments, cobalt is absent from the S-LRMO material or is present in a relatively small amount. For example, in some embodiments, the atomic percentage of cobalt in the S-LRMO is zero or is less than or equal to 10 at %, less than or equal to 5 at %, less than or equal to 2 at %, less than or equal to 1 at %, less than or equal to 0.5 at %, less than or equal to 0.2 at %, less than or equal to 0.1 at %, less than or equal to 0.05 at %, less than or equal to 0.02 at %, less than or equal to 0.01 at %, less than or equal to 0.005 at %, less than or equal to 0.002 at %, less than or equal to 0.001 at %, or less. Other ranges are also possible.

In some embodiments, the S-LRMO (e.g., as a cathode active material) is represented by the formula Li_{1.14}Na_{0.06}Mn_{0.6}Ni_{0.2}O₂. In some embodiments, the S-LRMO (e.g., as a cathode active material) is represented by the formula Li_{1.06}Na_{0.14}Mn_{0.6}Ni_{0.2}O. In some embodiments, the S-LRMO (e.g., as a cathode active material) is represented by the formula Li_{1.015}Na_{0.155}Mn_{0.18}Ni_{0.25}O₂. In some embodiments, the S-LRMO (e.g., as a cathode active material) is represented by the formula Li_{1.013}Na_{0.157}Mn_{0.52}Ni_{0.32}O₂. In some embodiments, the S-LRMO (e.g., as a cathode active material) is represented by the formula Li_{1.06}K_{0.14}Mn_{0.6}Ni_{0.2}O₂. The S-LRMO material can be formed using methods similar to the methods described above with respect to the LRMO material. For example, the S-LRMO material may be manufactured using precursor materials formed by sol-gel, solid state, or co-precipitate methods. The precursor materials may comprise metalloorganic precursors of Li, Na, K, Ca, Mg and one or more transition metals and/or Al. For example, the metalloorganic precursors may be selected from acetates, carbonates, nitrates, sulfates, and/or hydroxides of Li, Na, K, Ca, Mg, Mn, Ni and optionally Fe, Co, Al and/or Ti. In some embodiments, the precursors include a greater than or equal to 0.01 and less than or equal to 0.20 molar fractional excess of the of the lithium, sodium, and/or potassium metalloorganic precursors. In some embodiments, the precursors may include a greater than or equal to 0.01 and less than or equal to 0.20 molar fractional excess of the of the lithium and/or sodium metalloorganic precursors. For example, the sol-gel may include a greater than or equal to 0.01 and less than or equal to 0.20 molar fractional excess of the of the lithium and/or sodium metalloorganic precursors. In some embodiments, the precursors include a greater than or equal to 0.01 and less than or equal to 0.20 molar fractional excess of the lithium and/or sodium metal hydroxide precursors. For example, the sol-gel may include a greater than or equal to 0.01 and less than or equal to 0.20 molar fractional excess of the of the lithium and/or sodium metal hydroxide precursors. Other ranges are also possible. The precursors may be mixed (e.g., with a solution comprising water) to form a mixture. The mixture of the precursors may be heated to form a gel.

The precursors (e.g., as a mixture such as a gel) may be thermally decomposed (e.g., to form the LRMO material). The precursors may be fired at temperatures of greater than or equal to 250° C. and less than or equal to 600° C., such as greater than or equal to 300° C. and less than or equal to 500° C., for a time period of greater than or equal to 2 hours and less than or equal to 8 hours, such as greater than or equal to 4 hours and less than or equal to 6 hours, to thermally decompose the precursors and form an S-LRMO material. In some embodiments, the precursors may be thermally decomposed using microwave heating as discussed above. The decomposed precursor materials may then be sintered at a sintering temperature (e.g., to form the sintered S-LRMO material). The decomposed precursor materials may then be sintered at a temperature of at least 800° C., such as a temperature of greater than or equal to 850° C. and less than or equal to 1000° C., such as greater than or equal to 900° C. and less than or equal to 950° C., for a time period of greater than or equal to 8 hours and less than or equal to 14 hours, such as greater than or equal to 9 hours and less than or equal to 12 hours, or greater than or equal to 10 hours and less than or equal to 11 hours, to form a S-LRMO material. Other ranges are also possible.

In some embodiments, the S-LRMO material is sintered at a sintering temperature. The sintering temperature may refer to the temperature of the environment in which the S-LRMO is present during the sintering (e.g., a furnace temperature). In some embodiments, the sintering temperature is at least 800° C., at least 825° C., at least 850° C., at least 875° C., at least 900° C., or greater. In some embodiments, the sintering temperature is less than or equal to 1000° C., less than or equal to 950° C., less than or equal to 925° C., or less. Combinations of these values (e.g., at least 800° C. and less than or equal to 1000° C., at least 850° C. and less than or equal to 950° C., at least 900° C. and less than or equal to 950° C.) are possible. Other ranges are also possible.

The S-LRMO material may be ultra-rapidly quenched from a quenching temperature to room temperature in a quench fluid or bath as described above, to form an S-LRMO active material. For example, the S-LRMO material may be quenched from a sintering temperature of at least 800° C., such as a temperature of greater than or equal to 800° C. and less than or equal to 1000° C., or greater than or equal to 850° C. and less than or equal to 950° C., to room temperature (e.g., 25° C.), in less than or equal to 500 milliseconds, or less than or equal to 200 milliseconds, such as in time period of greater than or equal to 100 milliseconds and less than or equal to 500 milliseconds, greater than or equal to 200 milliseconds and less than or equal to 100 milliseconds. Other ranges are also possible. In some embodiments, the quenching temperature and the sintering temperature may be the same or substantially the same temperature.

In some embodiments, the quenching temperature is less than or equal to 800° C., less than or equal to 700° C., less than or equal to 600° C., less than or equal to 500° C., less than or equal to 400° C., less than or equal to 300° C., less than or equal to 200° C., or less than or equal to 100° C. In some embodiments, the quenching temperature is greater than or equal to 50° C., greater than or equal to 100° C., greater than or equal to 200° C., greater than or equal to 300° C., greater than or equal to 400° C., greater than or equal to 500° C., greater than or equal to 600° C., greater than or equal to 700° C., or greater than or equal to 800° C. Combinations of the above referenced ranges are also possible (e.g., less than or equal to 800° C. and greater than or equal to 100° C.). Other ranges are also possible.

The excess alkali and/or alkaline earth metals and Ni and Mn atoms may be homogeneously and uniformly distributed throughout transition metal crystal lattice sites in the S-LRMO material, such that there are no crystalline volumes greater than 3×3×3 nm in the material, in which there is a greater than 3% difference between ratios of Ni, Mn, A, and Li atoms, where A is at least one of Na, K, Ca or Mg, as compared to average ratios of the Ni, Mn, Na, K, Ca, Mg, and Li atoms of a bulk material.

According to various embodiments, the S-LRMO materials utilize a reduced amount of Li due to the substitution of Li with less costly elements. The S-LRMO materials thereby provide a reduction in material cost, as compared to unsubstituted LRMO materials. In addition, the S-LRMO materials also provide an unexpected capacity stability, rate capability, and an unexpectedly high voltage, as compared to conventional non-substituted LRMO materials. Additionally, it has been unexpectedly observed in the context of this disclosure that relatively high amounts of lithium in the LRMO material can be substituted with different cations (e.g., alkalis and/or alkaline earth metals such as sodium, potassium, magnesium, and/or calcium to form an S-LRMO) while maintaining substantially the same crystal structure and properties as non-substituted analogs. For example, it was surprising that relatively high levels of lithium substitution (e.g., greater than 5% and up to 20%) could be obtained without observing substantial occurrences of potentially deleterious phenomena such as the formation of second crystal phases. This stands in contrast to expectations from literature, where it had previously been reported for nickel and manganese-containing lithium metal oxide electrode active materials that when Na is used to replace some of the Li, a secondary crystalline phase (Na_{0.7}MnO₂) was observed (Du, K., et al. (2013). “Sodium additive to improve rate performance of Li[Li_{0.2}Mn_{0.54}Ni_{0.13}Co_{0.13}]O₂ material for Li-ion batteries.” Journal of Power Sources, 244, 29-34.). No substantial occurrence of such a secondary phase has been observed with the materials of this disclosure. Without wishing to be bound by any particular theory, it is believed that one contributing factor to the observed high level of substitution for lithium without disrupting desirable crystal and/or electrochemical properties is the use of the techniques of this disclosure (e.g., using rapid quenching such as in water).

In one embodiment, a method of forming an active material for a positive electrode of a lithium-ion battery comprises quenching a powder of the active material in water. In one embodiment, the method further comprises firing the active material powder prior to the quenching. The active material may be fired at a temperature of at least 800° C. The water may be at room temperature prior to the quenching, and the powder of the active material may be quenched at a rate of least 1750° C./second.

In one embodiment, the active material comprises layered substituted lithium-rich nickel manganese oxide. The excess Li, Ni and Mn atoms may be homogeneously and uniformly distributed throughout transition metal crystal lattice sites, such that there are no crystalline volumes greater than 3×3×3 nm in the material in which there is a greater than 3% difference between ratios of Ni, Mn and Li atoms compared to average ratios of the Ni, Mn and Li atoms of a bulk material. Particles of the powder of the active material may be in a shape of agglomerates which have an average size ranging from 0.1 μm to 20 μm, and the agglomerates of the powder of the active material are composed of crystallites having an average size ranging from 25 nm to 500 nm. The powder of the active material may comprise a composite of hexagonal and monoclinic phases after the quenching and is a combination of LiAMO₂R-3m and (LiA)₂MnO₃ C2/m phases, where M is at least one of Ni or Mn and A is some combination of non-lithium alkali and alkaline earth elements. The powder of the active material may comprise a solid solution with a crystal structure that predominately or completely possess a C2/m symmetry. The powder of the active material may comprise a solid solution with a crystal structure that predominately or completely possess a R-3m symmetry.

In one embodiment, the quench water comprises an additive solvated therein. The water may comprise greater than or equal to 0.01 moles per liter and less than or equal to 1.0 moles per liter of the additive. In one embodiment, the additive comprises an acid, which may be selected from sulfuric acid, citric acid, acetic acid, phosphoric acid, hydrochloric acid, ammonium phosphate, or combinations thereof. In another embodiment, the additive comprises a carbohydrate, which may be selected from fructose, galactose glucose, lactose, maltose, sucrose, or a combination thereof.

In one embodiment, the active material is placed into the positive electrode of the lithium-ion battery cell which further comprises a negative electrode and an electrolyte. In this context, the positive electrode corresponds to a cathode, and the negative electrode corresponds to an anode. The active material comprises hexagonal and monoclinic phases prior to the electrochemical cycling of the battery, and the active material powder does not comprise the monoclinic phase after the electrochemical cycling.

In one embodiment, the positive material in a battery cell has a specific capacity of at least 230 mAh/g (at a C/20 charge rate) after the 50 electrochemical cycles at the discharge rate of up to C/2.

In one embodiment, a lithium-ion battery cell comprises: a negative electrode; an electrolyte; and a positive electrode comprising a layered lithium rich nickel manganese oxide active material, wherein the he battery cell has a specific capacity of at least 215 mAh/g (at a C/20 rate) after the 50 electrochemical cycles at the discharge rate of up to C/2.

In one embodiment, particles of the powder of the active material are in a shape of agglomerates which have an average size of greater than or equal to 0.1 μm and less than or equal to 10 μm, and the agglomerates of the powder of the active material are composed of crystallites having an average crystal size of greater than or equal to 25 nm and less than or equal to 500 nm. Particles of the active material powder may have at least one of a spinel surface layer, a carbon coating or passivated oxygen bonds on a surface.

In some embodiments, fewer than 10% (e.g., fewer than 5%, fewer than 2%, fewer than 1%, fewer than 0.1%, or less) of the non-overlapping crystalline volumes greater than 3×3×3 nm in the material have a greater than 3% difference between ratios of Ni, Mn and alkali and/or alkaline earth metal atoms, as compared to average ratios of the Ni, Mn, Li, and alkali and/or alkaline earth metal atoms of a bulk material. Such a spatial distribution may be due to a high degree of cation disorder (e.g., due to homogeneous distribution of Li, K, Na, Ca, Mg, Ni, and/or Mn atoms). Other ranges are also possible.

In some embodiments, there are no crystalline volumes greater than 3×3×3 nm in the material in which there is a greater than 3% difference between ratios of Ni, Mn and alkali and/or alkaline earth metal atoms, as compared to average ratios of the Ni, Mn, Li, and alkali and/or alkaline earth metal atoms of a bulk material. Such a spatial distribution may be due to a high degree of cation disorder (e.g., due to homogeneous distribution of Li, K, Na, Ca, Mg, Ni, and/or Mn atoms).

In one embodiment, the included excess Li, K, Na, Ca, Mg, Ni, and/or Mn atoms are homogeneously and uniformly distributed throughout transition metal crystal lattice sites, such that there are no crystalline volumes greater than 3×3×3 nm in the material in which there is a greater than 3% difference between ratios of Ni, Mn and alkali and/or alkaline earth metal atoms, as compared to average ratios of the Ni, Mn, and Li atoms of a bulk material.

### EXAMPLES

The following example is intended to illustrate certain embodiments of the present invention, but do not exemplify the full scope of the invention.

### Example 1

An LRMO powder having the formula Liₓ(Mn_{y}Ni_{1-y})₂₋ₓO₂, where x=1.16 and y=0.7 was produced using the following method. In particular, a precursor material gel was produced using a sol-gel solid-state synthesis method. Synthesis of the sol included forming an aqueous mixture including stoichiometric amounts of Li(CH₃COO)*2H₂O, Mn(CH₃COO)₂*4H₂O, and Ni(NO₃)₂*6H₂O. The mixture was heated at 100° C. until the gel was formed. The gel was poured into an alumina crucible and then fired at 400° C. for 90 minutes, resulting in an ash devoid of organics. The resultant ash was ground and re-fired in the crucible at 500° C. for 3 hours and then allowed to naturally cool before being reground, after which the powder was sintered at 900° C. for 24 hours before being quenched. All sintering happened in a box furnace in ambient fume hood conditions. All quenching took place after 12-24 hours of heating at 900° C.

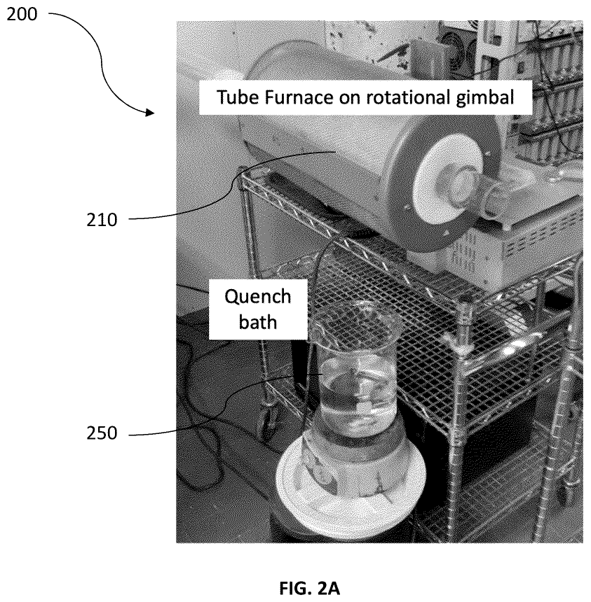

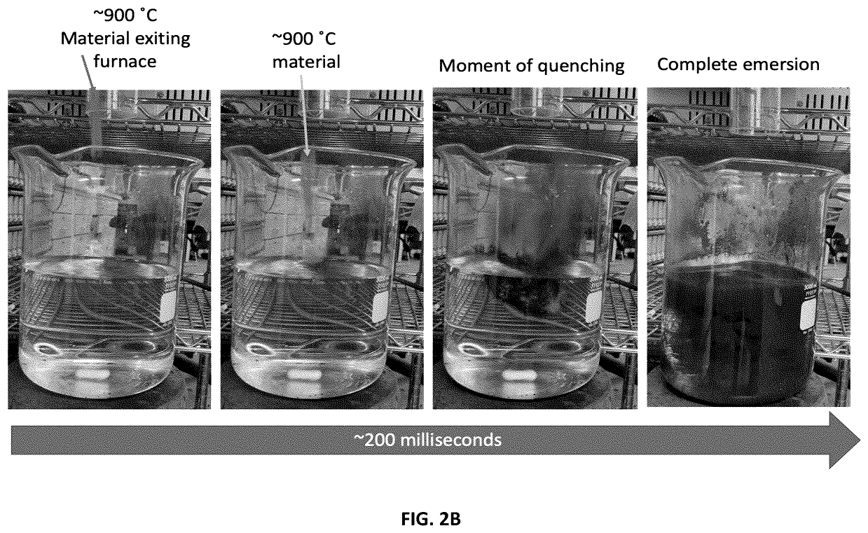

FIG. 2A is a photograph of a rapid quenching system 200 of according to an alternative embodiment of the present disclosure. FIG. 2B includes 4 sequential video capture time-lapse images filmed at 30 frames per second, showing a rapid quenching process, according to various embodiments of the present disclosure.

Referring to FIGS. 2A and 2B, the LRMO material was provided to a tube furnace 210, where the material is heated to 900° C. The heated LRMO material was output from the tube furnace 210 and quenched to room temperature in a quench bath 250. The tube furnace rotates 220 while operating such that its contents are instantly dumped into the quench bath 250. The time period between the time where the LRMO material exits the furnace 210 at 900° C. to time it is quenched to room temperature takes less than 500 milliseconds, such as less than 200 milliseconds to form a LRMO active material. After quenching, the LRMO material was filtered from the water of the quench bath 250 and dried in a vacuum oven.

In a first comparative example, the LRMO material was allowed to slowly cool in the furnace after the sintering at 900° C. In a second comparative example, the LRMO material was cooled by being dumped onto a metal plate after the sintering. In a third comparative example, the LRMO material was first cooled to room temperature slowly and then inserted into tube furnace 210 for the ultra-rapid quench step, which was kept at 900° C. for 30 to 120 minutes prior to the ultra-rapid quench step.

In alternative examples, LRMO power was formed using a rapid precursor decomposition process. In particular, the sol-gel precursor material described above was decomposed using microwave radiation to form an LRMO powder having improved component distribution. In particular, the application of microwave radiation resulted in rapid volatilization of the organic components of the precursor materials, due to the absorption of microwave energy by the organic components. As such, the LRMO components were homogeneously mixed on a molecular level due to the thermal energy generated by the microwave radiation. The resulting LRMO powder was then sintered for between 12 and 24 hours at 900° C. and then ultra-rapidly quenched as described above.

Multiple larger batches (up to 1 kg) of the cathode material were produced both with and without microwave decomposition and ultra-rapid quenching.

### Materials Characterization

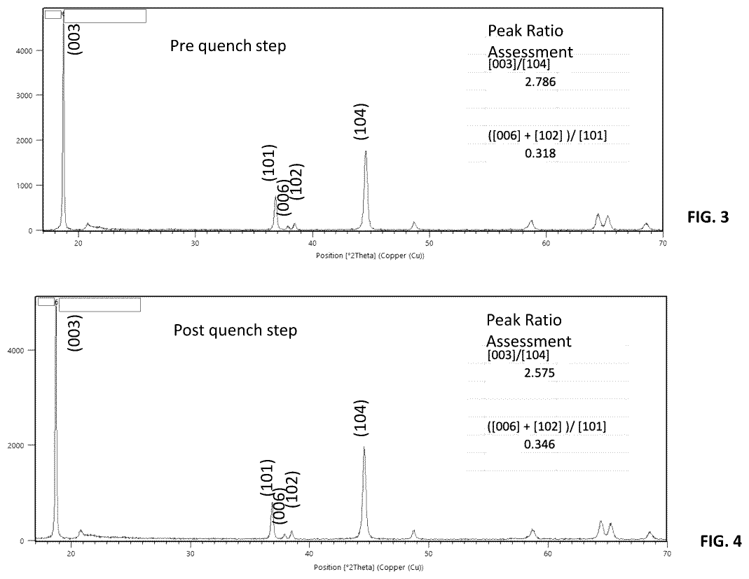

FIGS. 3 and 4 are graphs of X-ray diffraction (XRD) patterns for Liₓ(Mn_{y}Ni_{1-y})₂₋ₓO₂ materials, where x=1.2, and y=0.75, according to various embodiments of the present disclosure. The XRD pattern in FIG. 3 was generated from a layered LRMO active material that was not rapidly quenched via immersion in water, while the XRD pattern in FIG. 4 was generated from a layered LRMO active material that was rapidly quenched via immersion in water.

An assessment of the XRD patterns shows that the LRMO materials possess the expected hexagonal (e.g., rhombohedral) phase LiNiO₂-related, space group (R-3m) and a monoclinic phase (Li₂NiO₃-related, space group (C2/c).

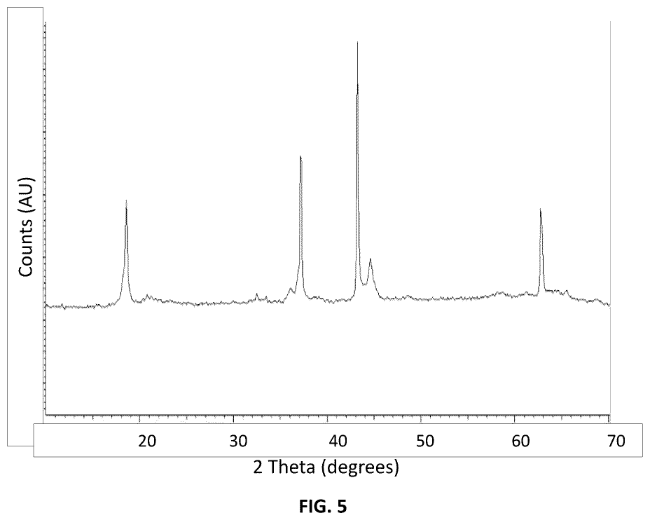

FIG. 5 is a graph showing X-ray diffraction results for a Liₓ(Mn_{y}Ni_{1-y})₂₋ₓO₂ material, where x=1.16, and y=0.7, that was processed using microwave heating of the sol-gel precursor materials for 5 minutes prior to the high temperature firing step, according to various embodiments of the present disclosure. Referring to FIG. 5, of key interest is the fact that this microwave decomposed material has a resultant x-ray diffraction pattern that is consistent with that of a highly crystalized and optimized material, including a rhombohedral phase LiNiO₂-related space group (R-3m) and a monoclinic phase Li₂NiO₃-related, space group (C2/c). Thus, the material is suitable for forming a LRMO using 900° C. annealing and rapid and/or ultra-rapid quenching, as described above.

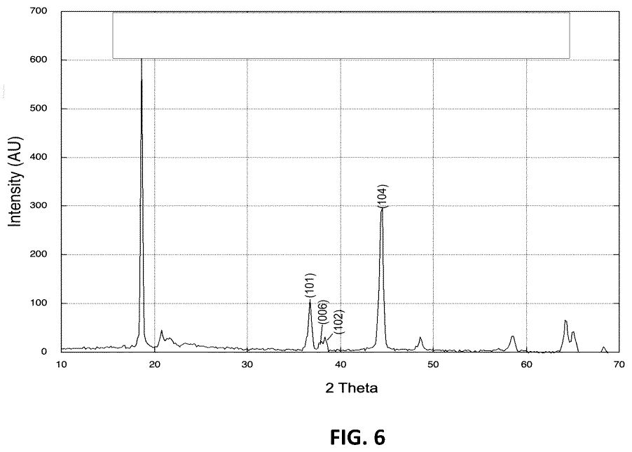

FIG. 6 is a graph illustrating X-ray diffraction results for a Liₓ(Mn_{y}Ni_{1-y})₂₋ₓO₂ material, where x=1.16, and y=0.7, that was processed using microwave heating and ultra-rapid quenching, according to various embodiments of the present disclosure. Referring to FIG. 6, all expected peaks are present and well defined.

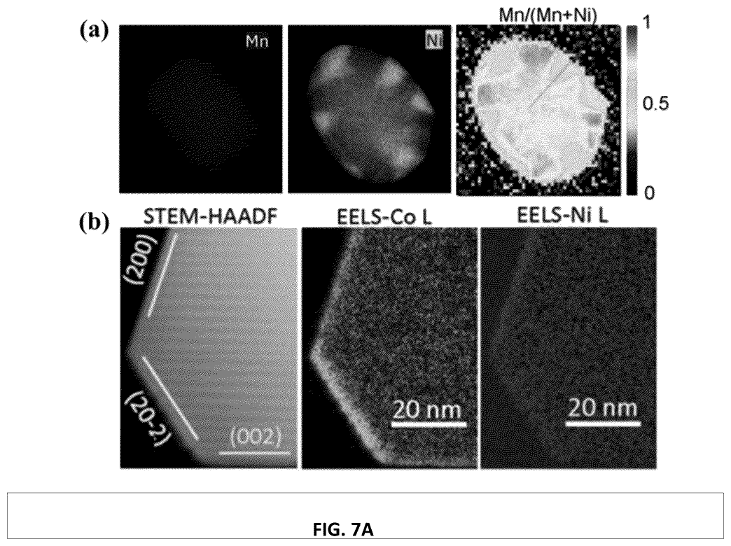

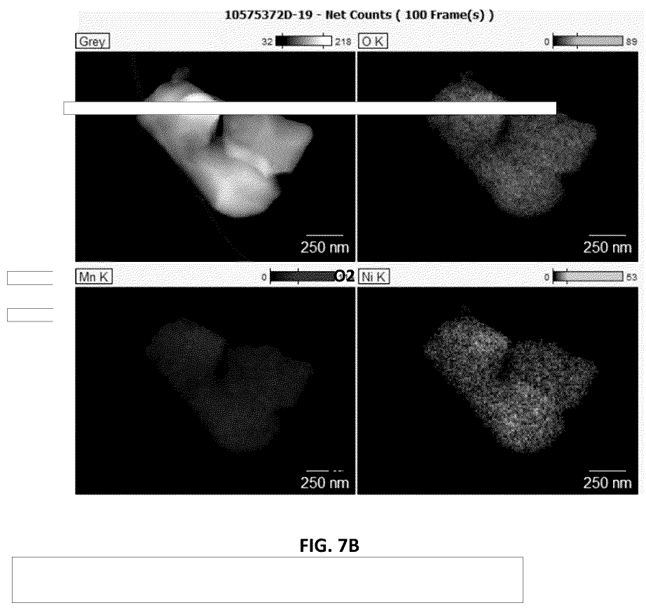

FIG. 7A is an example from the literature (H. Zheng, et al., “Recent developments and challenges of Li-rich Mn-based cathode materials for high-energy lithium-ion batteries”, Materials Energy Today, Volume 18, December 2020, Page 100518) of tunneling electron microscopy (TEM) high-angle annular dark-field imaging (HAADF) atomic map micrograph of typical LRMO material that has not been subjected to rapid quenching prior to electrochemically cycling the material. As can be seen from the micrographs shown in FIG. 7A, the initial LRMO material had significant nickel and manganese segregation inside the particles,

FIG. 7B is a TEM HAADF atomic map micrograph of produced LRMO material that was subjected to rapid quenching prior to electrochemically cycling the material, according to various embodiments of the present disclosure. As can be seen from the micrographs in FIG. 7B, the LRMO material had no significant nickel/manganese segregation in the particle. Thus, the rapid or ultra-rapid quenching reduces or eliminates the nickel segregation to the surface of the particles, and nickel and manganese are evenly mixed in the bulk of the LRMO material.

### Crystalline Uniformity, Cation Disorder, and Surface Passivation

One method to assess the degree of metal cation disorder in the materials is to use the ratio of peak intensities in the x-ray diffraction patterns. Specifically, the ratio of the intensity of the (003) peak to the (104) peak is commonly known as rough measurement of electrochemical activity in mixed cation materials with this predominately layered crystal structure, while the ratio of the sum of the intensities of (006) and (102) peaks to the intensity of the (101) peak is an indicator of cation disorder. Based on this, the material that has been both microwave-processed during the decomposition stage and then ultra-rapidly quenched offers significantly higher indications of electrochemical activity and lower degree of cation order (and therefore a higher degree of cation disorder) than slow cooled material.

TABLE 2
XRD Peak Ratios

| | (003)/(104): | [(006) + (102)]/(101): |
|---|---|---|
| | higher is more | higher is higher |
| | electrochemically | cation mixing/ |
| | active | disorder |
| Comparative example: | 2.79 | 0.318 |
| slow cooling | | |
| Example: ultra-rapid | 2.575 | 0.346 |
| quenching | | |

Table 2 shows XRD peak intensity ratios for a comparative example LRMO material subjected to a slow quench after sintering (row 1), and for an exemplary LRMO material made subjected to the ultra-rapid quench after sintering (row 2). Both materials have formula Liₓ(Mn_{y}Ni_{1-y})₂₋ₓO₂ where x=1.2, and y=0.75. Importantly, the exemplary ultra-rapidly quenched material exhibits XRD characteristics that show an increase in atomic disordering in the material that have significantly higher electrochemical activity and more cation disorder/metal oxide homogeneity than the comparative example material. Specifically, the exemplary material shows an increase in the ratio of the sum of the intensities of (006) and (102) peaks to the intensity of the (101) peak, in this case of 9%. This significant increase in cation disorder represents a situation where the Ni and Mn atoms are more completely mixed (and are therefore not grouped) in the material. For this reason, such exemplary material may be referred to as “cation-disordered lithium-rich lithium manganese nickel oxide”, and these data demonstrate that different states of matter can be created based on the processing conditions used, and in particular, the rate of cooling used.

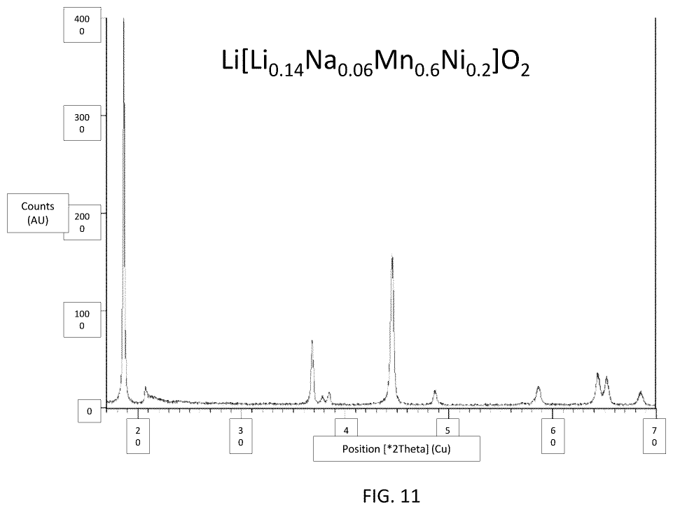

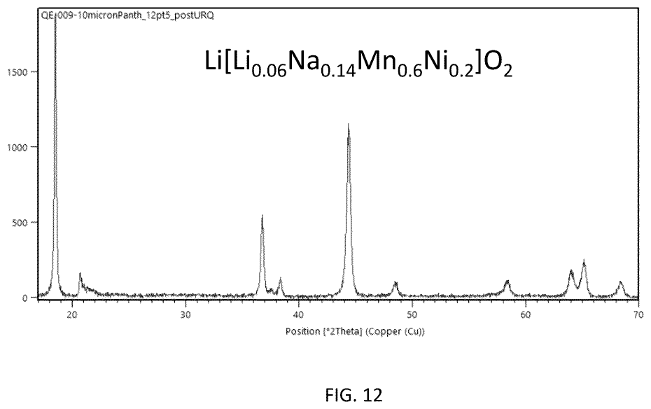

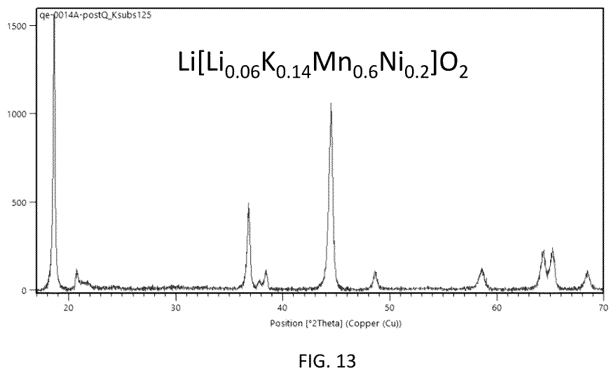

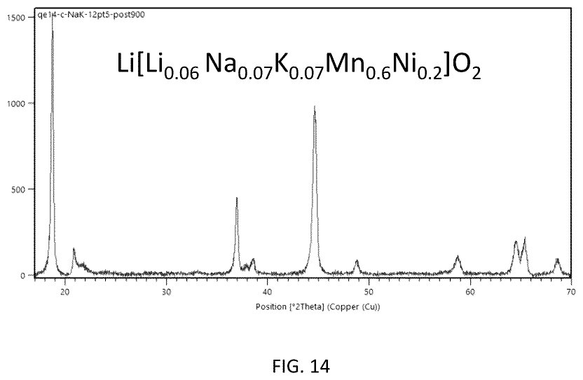

FIGS. 11-14 are charts showing X-ray diffraction pattern results for S-LRMO materials including various amounts of Na and/or K as described in the previous section, according to various embodiments of the present disclosure. The S-LRMO materials were prepared using to the above-disclosed thermal processing and ultra-rapid quenching processes. As shown in FIGS. 11-14, the S-LRMO materials had the classical phase purity of an LRMO material. The XRD data is also consistent with a material that exhibits a high degree of cation mixing/disorder in the transitional sites in the material.

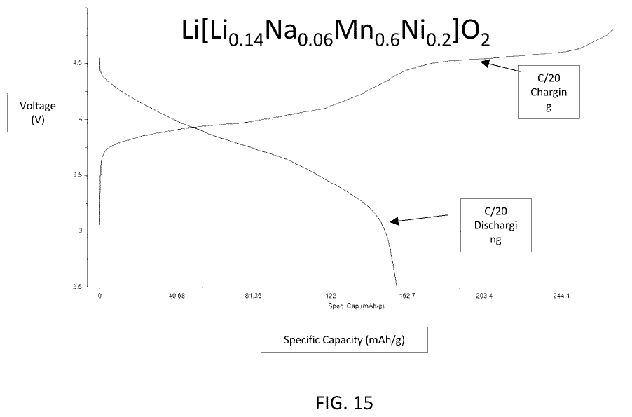

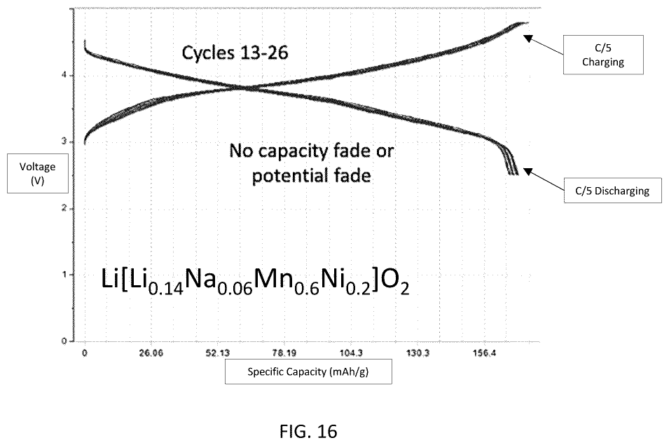

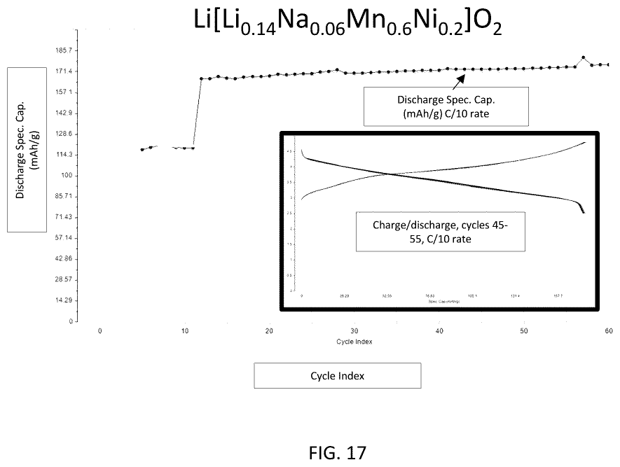

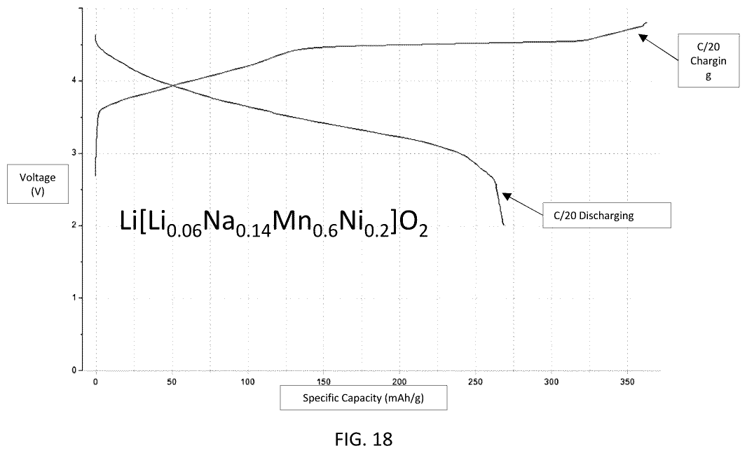

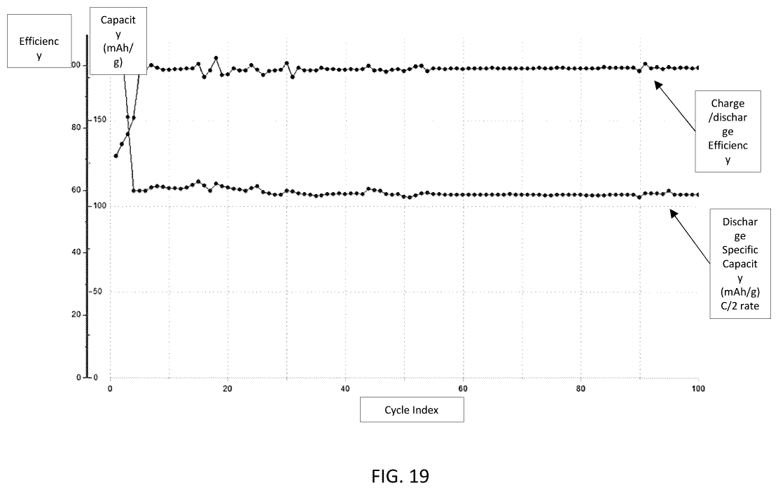

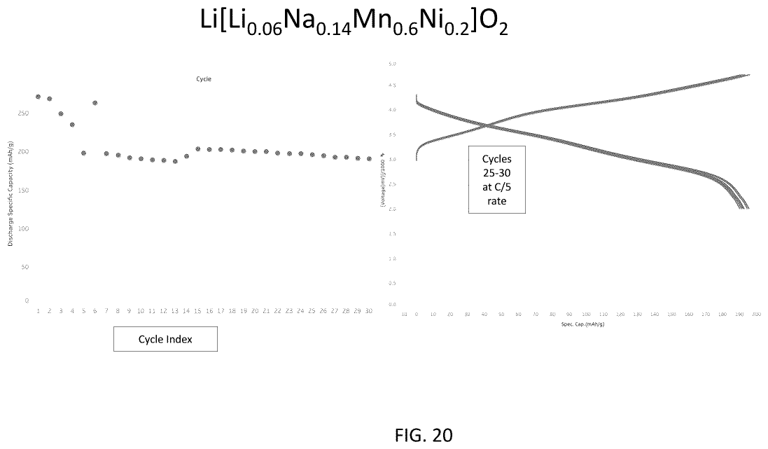

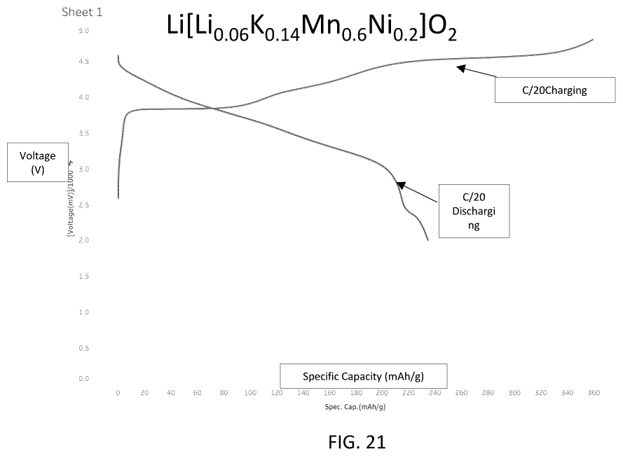

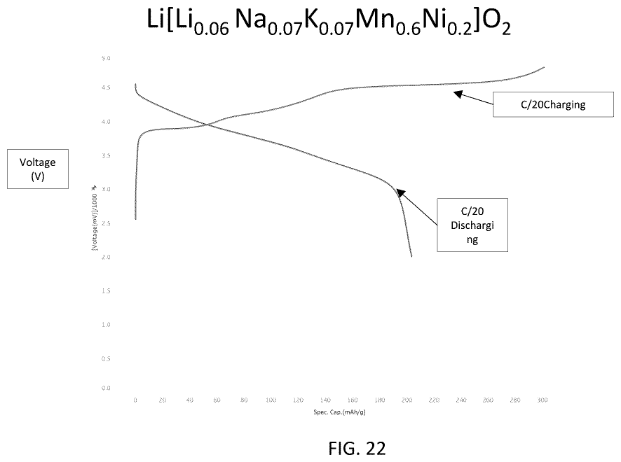

FIGS. 15 to 22 are graphs showing the electrochemical performance of lithium ion cells formed using various identified S-LRMO materials. In particular, FIGS. 15 and 16 are graphs of voltage versus specific capacity for the first two cycles and for cycles 13-26 of the S-LRMO material containing cells, respectively, where the S-LRMO material formula is Li[Li_{0.14}Na_{0.06}Mn_{0.6}Ni_{0.2}]O₂. FIG. 17 is a graph of discharge specific capacity versus cycle number (i.e., cycle stability) and the inset is a graph of voltage versus specific capacity of the S-LRMO material containing cell, where the S-LRMO material formula is Li[Li_{0.14}Na_{0.06}Mn_{0.6}Ni_{0.2}]O₂. FIG. 18 is a plot of charge and discharge specific capacity (i.e., voltage vs. specific capacity) of cells containing the S-LRMO material, where Na is 12.5% substituted for lithium. FIG. 19 is a plot of cycle number versus charge-discharge efficiency and discharge specific capacity for 100 cycles of a cell containing the S-LRMO active material. FIG. 20 includes a graph of discharge specific capacity versus cycle number (i.e., cycle stability) on the left side and a graph of voltage versus specific capacity on the right side, of the S-LRMO material containing cell. The S-LRMO material formula in FIGS. 18-20 is Li[Li_{0.06}Na_{0.14}Mn_{0.6}Ni_{0.2}]O₂. FIGS. 21 and 22 are graphs of voltage versus specific capacity for the first two cycles of the S-LRMO material containing cells, where the S-LRMO material formula is Li[Li_{0.06}K_{0.14}Mn_{0.6}Ni_{0.2}]O₂ and Li[Li_{0.06}Na_{0.07}K_{0.07}Mn_{0.6}Ni_{0.2}]O₂, respectively.

As shown in FIGS. 15-22, the S-LRMO active material had excellent performance and stability, with little to no capacity fade over many cycles, in contrast to the rapid capacity and voltage fade exhibited by conventional Li-rich materials.

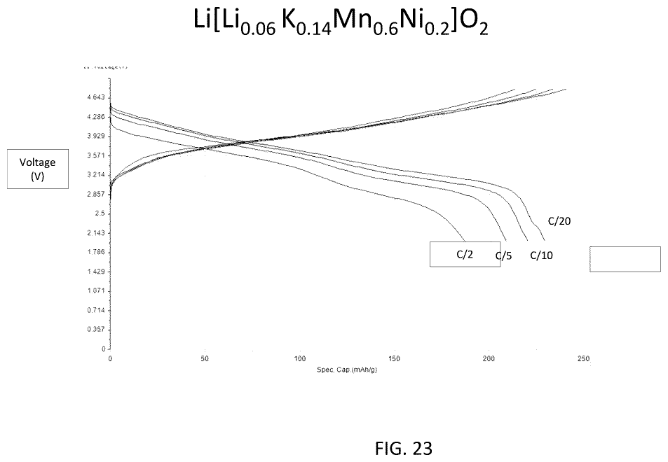

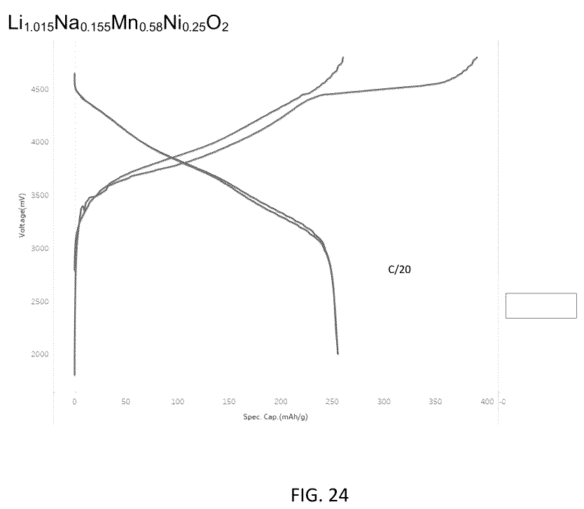

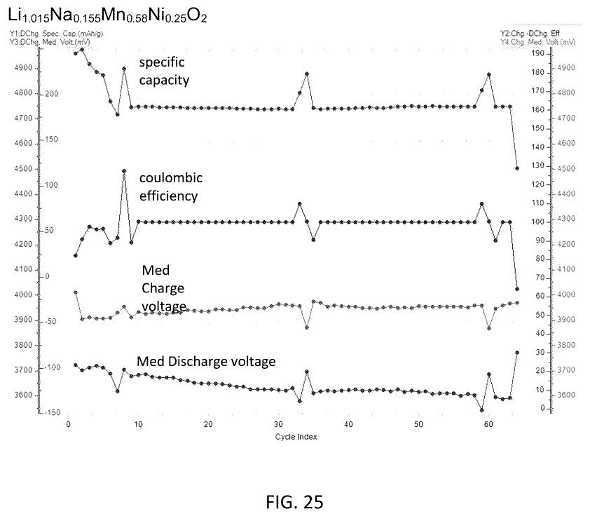

FIG. 23 is a graph of voltage versus specific capacity showing discharge rate data of the Li[Li_{0.06}K_{0.14}Mn_{0.6}Ni_{0.2}]O₂ material. As shown in FIG. 23, the material is highly rate capable and has a capacity of approximately 180 mAh/g at a C/2 rate. This good rate capability may be a result of the alkali atom in the crystalline material creating a more facile lithium ion transport path in the system, thereby enabling better conductivity and rate performance.

In particular, the S-LRMO active material exhibited a stable capacity and voltage profile, offering a significant improvement over conventional LRMO materials having similar compositions but that are not substituted or thermally processed (e.g., not rapidly quenched) as described above. Cells including the S-LRMO active material demonstrated a specific capacity of over 260 mAh/g, such as from 265 to 275 mAh/g, at a C/20 rate. As shown in FIG. 16, cells including the Li_{1.14}Na_{0.06}Mn_{0.6}Ni_{0.202} active material showed stable discharge specific capacity and charge/discharge efficiency over dozens of cycles, thereby demonstrating excellent stability and cycle life. Accordingly, the S-LRMO active material exhibits less than 10% loss (e.g., less than 5% loss, less than 2% loss, or less) in average discharge voltage at a C/20 rate after 200 charge/discharge cycles of a lithium-ion battery, and/or less than 5% capacity fade (e.g., less than 3% capacity fade, less than 2% capacity fade, or less) over 200 C/4 charge/discharge cycles of the lithium-ion battery, and/or over 200 mAh/g specific capacity (e.g., over 230 mAh/g specific capacity, over 250 specific capacity, or greater) when charged and discharged at a C/20 rate, and/or a C/2 discharge specific capacity that is at least 75% (e.g., at least 80%, at least 85%, at least 90%, or more) the C20 discharge specific capacity.

The X-ray data shown in FIGS. 11-14 also shows that high degrees of lithium substitution (e.g., of at least 12.5%) can be accommodated without the crystal structure of the LRMO being substantially affected or the creation of secondary crystalline phases. All of these x-ray diffraction patterns display only the expected lithium-rich crystalline phase structure regardless of type and amount of substitutional material used. TEM/EDS data showed that, in this example of a 5% Na substitutional material, there was still an even spatial distribution of Mn and Ni throughout the samples.

### Electrochemical Testing

Synthesized cathode materials were mixed with Super-P carbon black and polyvinylidene fluoride (PVDF) in a ratio of 8:1.2:0.8 making the active material 80% of the overall mass. The resultant blend was then mixed into ˜15 ml of N-Methyl-2-Pyrrolidone for a minimum of one hour before two 10-minute sonication steps, after which the resultant slurry was further allowed to mix on a hot plate at 100° C. for a minimum of 30 minutes before being spray coated onto 10×10 cm, 10 μm thick aluminum foil heated above 100° C. Foil was allowed to dry in a 70° C. oven in air over night before being punched out with a biopsy punch. These punches were then used to make 2032 coin cells that used lithium foil as the anode, 1.0 M LiPF₆ 50/50 ethylene carbonate/dimethyl carbonate solution as the electrolyte, a Celgard battery separator, 0.5 mm stainless steel spacers, and wave springs on the cathode side to ensure mechanical contact within the cell; each coin cell was assembled and sealed through use of a coin cell press in a dry low oxygen argon atmosphere.

The electrochemical performance investigations used low-current Neware or bio-logic battery testers to conduct potential limited galvanostatic testing with constant current on the coin cells made in the process described above. The cells were cycled using constant current charge/discharge conditions at rates ranging from C/20 to C/2 between 4.8 and 2 V.

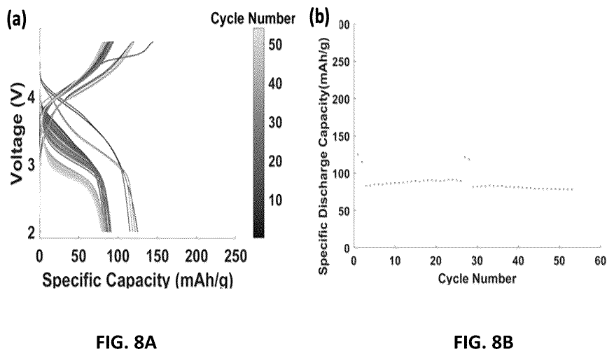

FIG. 8A is a graph showing cell potential vs. specific capacity, and FIG. 8B is a graph of the specific capacity vs cycle for a comparative example of a LRMO material (Liₓ(Mn_{y}Ni_{1-y})₂₋ₓO₂, where x=1.16, and y=0.7) that was not microwave processed or rapidly quenched (in this case cooled relatively slowly on a metal plate). Referring to FIGS. 8A and 8B, it can be seen that the slow cooled material had poor capacity and capacity retention. After 50 full charge/discharge (C/2 rate) cycles, this material yielded specific capacity of 120 mAh/g at a C/20 rate, which is far below the theoretical performance of this material. Further, there was substantial voltage fade in the material, where the average discharge potential was below 3V after 30 cycles.

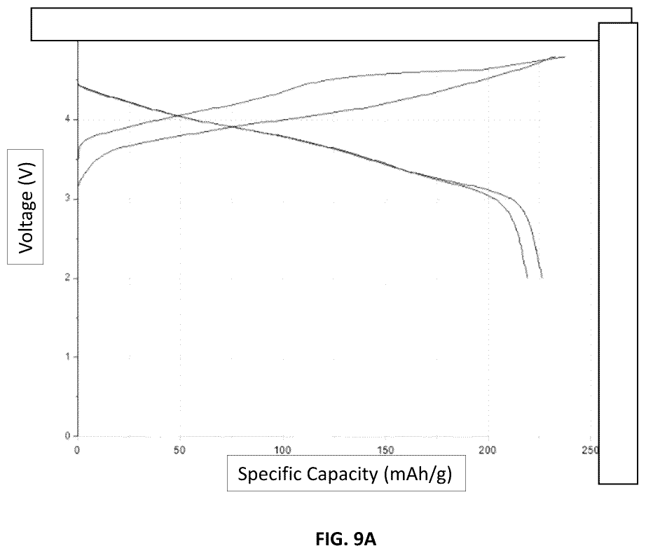

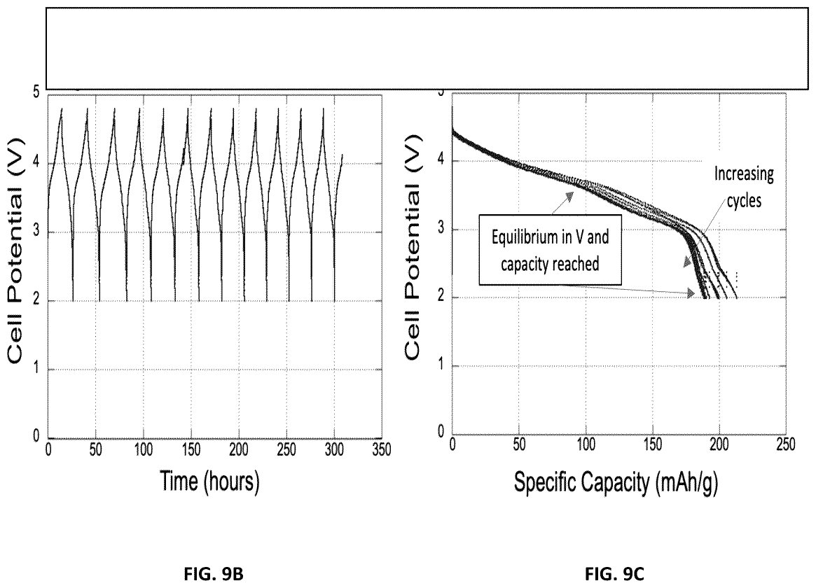

FIG. 9A is a graph showing cell potential vs. specific capacity during break-in cycles of ultra-rapidly quenched material, FIG. 9B is a graph showing cell potential vs specific capacity over time of ultra-rapidly quenched material, and FIG. 9C is a graph showing specific capacity vs cycle at C/20 rates over multiple cycles, for exemplary cells including LRMO active materials according to various embodiments of the present disclosure.

In contrast to the comparative exemplary material shown in FIGS. 8A-8B, the exemplary LRMO cathode material made using an ultra-rapid quench performed well, as shown in FIGS. 9A-9C. The electrochemical performance data in FIGS. 9A and 9B demonstrates both that: (a) highly functional materials can be produced at meaningful scale, and that (b) these materials have performance properties that meet or exceed the much smaller batches produced. Notably, the voltage profile has an exaugurated and desirable inflection after approximately 100 mAh/g of discharge capacity compared to the materials made using slower cooling methods. The voltage trace above this inflection point demonstrates virtually no “sag” or loss during cycling, which is improved compared to materials made using the slower transfer technique. This suggests that the ultra-rapid cooling approach implemented using a gravity-driven transfer from the furnace to the quench environment in under 200 milliseconds is desirable when combined with rapidly decomposed precursors via microwave irradiation.

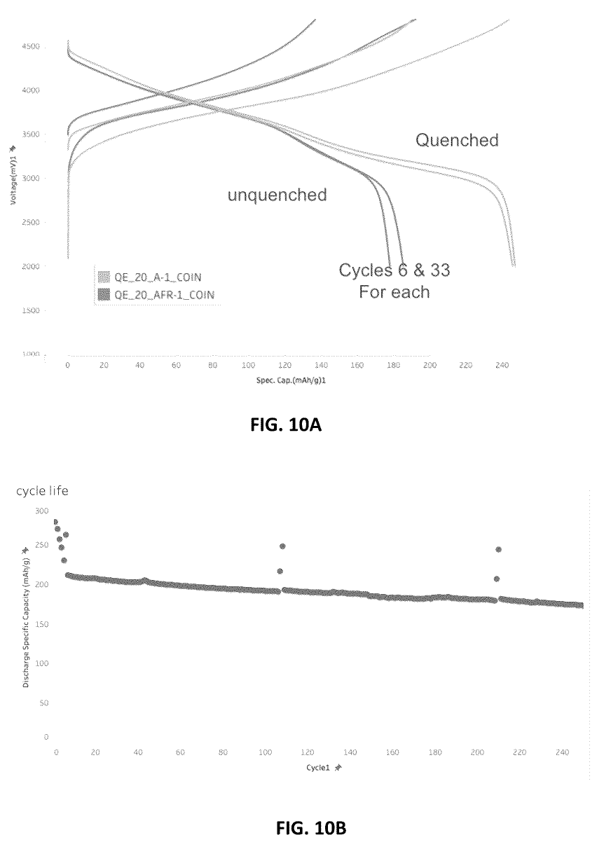

FIG. 10A is a graph showing cell potential vs specific capacity of cells containing materials that both have and have not been through the quenching process as described. The quenched material delivers significantly more specific capacity and is extremely stable under cycling, as shown in FIG. 10B, which is a specific capacity vs. cycle data set for material that has been processed using this process tool.

| | Discharge Capacities (mAh g⁻¹) | | | | | | (C/20):(C/2) |
|---|---|---|---|---|---|---|---|
| | DC1 | DC2 | DC3 | DC27 | DC28 | DC54 | DC28/DC27 |
| 25Hq | 186 | 200 | 190 | 217 | 258 | 245 | 1.19 |
| 25Lq | 180 | 175 | 152 | 160 | 200 | 160 | 1.25 |
| 25Mq | 127 | 120 | 80 | 90 | 125 | 75 | 1.39 |
| 17Hq | 195 | 205 | 175 | 197 | 255 | 205 | 1.29 |
| 17Lq | 110 | 120 | 107 | 150 | 190 | 160 | 1.27 |
| 17Mq | 110 | 120 | 90 | 150 | 210 | 170 | 1.40 |
| 10Hq | 35 | 40 | 37 | 110 | 140 | 165 | 1.27 |
| 10Lq | 75 | 77 | 60 | 75 | 120 | 87 | 1.60 |
| 10Mq | 75 | 80 | 55 | 75 | 125 | 90 | 1.67 |

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, and/or method described herein. In addition, any combination of two or more such features, systems, articles, materials, and/or methods, if such features, systems, articles, materials, and/or methods are not mutually inconsistent, is included within the scope of the present invention.

As used herein in the specification and in the claims, the phrase “at least a portion” means some or all, unless clearly indicated to the contrary. “At least a portion” may mean, in accordance with certain embodiments, at least 1 wt %, at least 2 wt %, at least 5 wt %, at least 10 wt %, at least 25 wt %, at least 50 wt %, at least 75 wt %, at least 90 wt %, at least 95 wt %, or at least 99 wt %, and/or, in certain embodiments, up to 100 wt %.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

Unless clearly indicated to the contrary, concentrations and percentages described herein are on a mass basis.

As used herein, “wt %” is an abbreviation of weight percentage. As used herein, “at %” is an abbreviation of atomic percentage.

Some embodiments may be embodied as a method, of which various examples have been described. The acts performed as part of the methods may be ordered in any suitable way. Accordingly, embodiments may be constructed in which acts are performed in an order different than illustrated, which may include different (e.g., more or less) acts than those that are described, and/or that may involve performing some acts simultaneously, even though the acts are shown as being performed sequentially in the embodiments specifically described above.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

In the claims, as well as in the specification above, all transitional phrases such as “comprising,” “including,” “carrying,” “having,” “containing,” “involving,” “holding,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. A thermal processing system, comprising:
a furnace configured to sinter a powder at a sintering temperature, wherein the furnace is configured to agitate the powder during at least a portion of time during which the powder is sintered;
a quenching apparatus configured to quench at least a portion of the sintered powder in a quench fluid; and
a transfer conduit configured to provide the at least a portion of the sintered powder having the sintering temperature from the furnace to the quenching apparatus in 500 ms or less.

2. The thermal processing system of claim 1, wherein the furnace is a rotary furnace, a furnace configured to agitate via vibration, and/or a fluidized bed furnace.

3. The thermal processing system of claim 1, wherein the furnace is a rotary furnace.

4. The thermal processing system of claim 3, wherein the furnace is a tilted rotary furnace.

5. A thermal processing system, comprising:
a tilted rotary furnace configured to heat a powder at a first temperature;
a quenching apparatus configured to quench at least a portion of the heated powder in a quench fluid at a second temperature; and
a transfer conduit configured to provide the at least a portion of the heated powder having the first temperature from the tilted rotary furnace to the quenching apparatus in 500 ms or less.

6. The thermal processing system of claim 1, wherein:
the quenching apparatus is located below the furnace; and
the transfer conduit comprises a substantially vertical tube connecting at least one outlet of the furnace to an inlet of the quenching apparatus and configured to provide the at least a portion of the sintered powder from the tilted rotary furnace to the quenching apparatus at least in part by a force of gravity.

7. The thermal processing system of claim 6, wherein:
the transfer conduit is configured to provide the at least a portion of the sintered powder having the sintering temperature from the tilted rotary furnace into the quenching apparatus at a quenching temperature that is less than the sintering temperature by a value of greater than or equal to 0° C. and less than or equal to 200° C.; and
the quenching apparatus is configured to quench the at least a portion of the powder from the quenching temperature to a temperature of less than or equal to 120° C. in 500 ms or less.

8. The thermal processing system of claim 7, wherein the quenching apparatus is configured to quench the at least a portion of the powder from the quenching temperature to room temperature in 500 ms or less.

9. The thermal processing system of claim 7, wherein:
the transfer conduit comprises thermal insulation configured to limit cooling of the powder and a heater configured to heat the transfer conduit to at least the quenching temperature.

10. The thermal processing system of claim 7, wherein the sintering temperature is greater than or equal to 800° C. and less than or equal to 1000° C.

11. The thermal processing system of claim 7, wherein the sintering temperature is greater than or equal to 850° C. and less than or equal to 1000° C.

12. The thermal processing system of claim 3, wherein the quenching temperature is less than or equal to 500° C.

13. The thermal processing system of claim 1, wherein the powder comprises a lithium-rich metal oxide (LRMO) material powder.

14. The thermal processing system of claim 6, wherein at least a portion of the transfer conduit extends into the quenching apparatus to form an air seal with quench fluid in the quenching apparatus when the quench fluid is present.

15. The thermal processing system of claim 1, wherein the quenching apparatus comprises a vessel containing a stirrer and configured to hold quench fluid when the quench fluid is present.

16. The thermal processing system of claim 1, wherein the quenching apparatus comprises a continuous liquid loop quenching apparatus.

17. The thermal processing system of claim 1, wherein the quenching apparatus comprises a quench fluid.

18. The thermal processing system of claim 16, wherein the continuous liquid loop quenching apparatus comprises:
a quench conduit configured to receive the at least a portion of the powder from the transfer conduit and quench the at least a portion of the powder in the quench fluid when the quench fluid is present;
a separator vessel configured to separate at least a portion of the quenched powder from the quench fluid;
a pump configured to pump the quench fluid through the quench conduit; and
a return conduit configured to provide the quench fluid from the separator vessel to the pump.

19. The thermal processing system of claim 16, wherein the continuous liquid loop quenching apparatus comprises:
a quench conduit configured to receive the at least a portion of the powder from the transfer conduit and quench the at least a portion of the powder in the quench fluid when the quench fluid is present;
a separator vessel comprising a batch or continuous centrifuge configured to receive at least a portion of the quenched powder and quench fluid, wherein the centrifuge is configured to separate at least a portion of the quenched powder and send the quench fluid to be collected in a holding vessel configured to pump at least a portion of the quench fluid back to the quench conduit;
a pump configured to pump the quench fluid through the quench conduit; and
a return conduit configured to provide the quench fluid from the centrifuge holding vessel to the pump.

20. The thermal processing system of claim 1, wherein the furnace comprises:
a process conduit comprising an inlet and an outlet, the process conduit configured to convey a powder through the furnace;
a drum housing the process conduit and configured to heat the process conduit to the sintering temperature; and
a motor configured to rotate at least the process conduit.

21. The thermal processing system of claim 20, wherein the furnace comprises a base which supports the drum at a non-zero angle with respect to a horizontal direction, such that the inlet of the process conduit is higher than the outlet of the process conduit which is fluidly connected to an inlet of the transfer conduit.

22. The thermal processing system of claim 20, wherein the outlet of the process conduit comprises multiple openings arranged in an annular pattern around a sidewall of the process conduit and that extend through a sidewall of the drum to the inlet of the transfer conduit.

23. A method, comprising:
sintering a powder at a sintering temperature in a furnace;
agitating at least a portion of the powder during the sintering; and
providing at least a portion of the sintered powder having the sintering temperature from the furnace at least in part by a force of gravity through a transfer conduit into a quench fluid in a quenching apparatus in 500 ms or less.

24-26. (canceled)

27. A method, comprising:
sintering a powder at a sintering temperature in a tilted rotary furnace; and
providing at least a portion of the sintered powder having the sintering temperature from the tilted rotary furnace at least in part by a force of gravity through a transfer conduit into a quench fluid in a quenching apparatus in 500 ms or less.

28-44. (canceled)

45. The thermal processing system of claim 1, wherein the powder is heated to a temperature sufficient to encourage a relatively high degree of atomic disorder in the powder material.

46. The thermal processing system of claim 1, wherein the quenching apparatus is configured such that at least a portion of the particles within the quenching apparatus undergoes substantially the same change in temperature over time.

47. The thermal processing system of claim 1, wherein the furnace further comprises an exit port positioned such that the sintered powder particles exit the furniture at the heated temperature before entering the quench fluid.

48. The thermal processing system of claim 47, wherein the exit port is positioned within a hot zone of the furnace.

49. The thermal processing system of claim 6, wherein the vertical tube is hermetically sealed.

50. The thermal processing system of claim 1, wherein quenched powder forms a slurry suitable for transporting away from the quenching environment.

51. The thermal processing system of claim 1, further comprising a slurry pump.

52-53. (canceled)
